(19) United States
(12) Patent Application Publication
(10) Pub. No.: US 2023/0399124 A1
(43) Pub. Date: Dec. 14, 2023

(54) DESIGN METHODS AND MOTION CONTROL ALGORITHMS FOR IMPACT-RESILIENT MOBILE ROBOTS

(71) Applicant: THE REGENTS OF THE UNIVERSITY OF CALIFORNIA, Oakland, CA (US)

(72) Inventors: Konstantinos KARYDIS, Laguna Beach, CA (US); Zhichao LIU, Moreno Valley, CA (US); Zhouyu LU, Riverside, CA (US)

(73) Assignee: THE REGENTS OF THE UNIVERSITY OF CALIFORNIA, Oakland, CA (US)

(21) Appl. No.: 18/034,603

(22) PCT Filed: Oct. 28, 2021
(86) PCT No.: PCT/US2021/057128

§ 371 Date: Apr. 28, 2023

Related U.S. Application Data
(60) Provisional application No. 63/106,772, filed on Oct. 28, 2020.

(51) Int. Cl. B64D 45/00; G01D 5/14; G05D 1/10

(52) U.S. Cl. CPC B64D 45/00; G01D 5/142; G05D 1/106; B64U 10/14

(57) ABSTRACT

An apparatus and method for detecting a collision of an aerial vehicle and recovery from the collision is disclosed. An apparatus for use in an aerial vehicle includes an arm, a flexible member and a sensing system. A processor is configured to receive a collision signal after deformation of the collision-resilient robot from a collision, recover control of the collision-resilient robot after the collision, and plan a post-collision trajectory for the collision-resilient robot using a global search-based planner.

### CROSS-REFERENCE TO RELATED APPLICATION

This application claims the benefit of priority of U.S. Provisional Application Ser. No. 63/106,772 filed on Oct. 28, 2020, which application is incorporated by reference herein.

### GOVERNMENT FUNDING

This invention was made with government support under 1910087 awarded by the National Science Foundation. The government has certain rights in the invention.

### FIELD

The subject matter of the present disclosure relates to methods and systems for robots and aerial vehicles capable of sensing a collision and recovering from the collision.

### BACKGROUND

Robots and aerial vehicles experience collisions. Often the collisions damage the robots or aerial vehicles. There exists a need for collision-resilient robots and aerial vehicles that can recover from collisions and continue their tasks.

### SUMMARY

Consistent with the disclosed embodiments, an apparatus for use in an aerial vehicle is disclosed. The apparatus comprises an arm. The arm comprises a first substrate, a second substrate, and a flexible member having a longitudinal axis and a length, the flexible member to couple the first substrate to the second substrate. The apparatus comprises a sensing system mounted on the arm, the sensing system to detect changes in the length of the flexible member. In some embodiments, the flexible member comprises a prismatic joint. In some embodiments, the flexible member comprises a shock absorber. In some embodiments, the sensing system comprises a signal source mounted on the first substrate. In some embodiments, the signal source comprises a magnet. In some embodiments, the sensing system comprises a Hall effect sensor mounted on the flexible member.

Consistent with the disclosed embodiments, the apparatus comprises an aerial vehicle including an arm including a flexible member having a length, and a sensing system included in the aerial vehicle, the sensing system to detect a change in the length. In some embodiments, the sensing system includes a Hall effect sensor. In some embodiments, the arm includes a shock absorber adjusted such that the length of the arm remains substantially unchanged during free flight. In some embodiments, the shock absorber comprises a passive spring. In some embodiments, the apparatus further comprises a collision recovery control system communicatively coupled to the sensing system. In some embodiments, the collision recovery control system comprises a single stage collision recovery control system. In some embodiments, the aerial vehicle comprises a quadrotor. In some embodiments, the apparatus further comprises a protective structure mechanically coupled to the arm.

Consistent with the disclosed embodiments, a method comprises generating a collision signal for an aerial vehicle in response to a collision, and processing the collision signal to identify an axis of the aerial vehicle from which the collision signal originated. In some embodiments, generating the collision signal for the aerial vehicle in response to the collision comprises detecting compression of an arm of the aerial vehicle. In some embodiments, generating the collision signal for the aerial vehicle in response to the collision comprises processing a Hall effect sensor signal generated from a change in a length of a flexible member included in the aerial vehicle. In some embodiments, generating the collision signal for the aerial vehicle in response to the collision comprises detecting the collision without inertial measurement unit data. In some embodiments, the method comprises estimating deformation of the aerial vehicle resulting from the collision. In some embodiments, the method further comprises processing the collision signal to identify an intensity of the collision.

Consistent with the disclosed embodiments, the method comprises generating a collision signal from compression of a flexible member resulting from a mid-air collision of an aerial vehicle including the flexible member, and processing the collision signal and initiating execution of a recovery operation to sustain and resume flight of the aerial vehicle following the mid-air collision. In some embodiments, processing the collision signal and initiating execution of the recovery operation to sustain and resume flight of the aerial vehicle following the mid-air collision comprises processing the collision signal to identify an intensity of the mid-air collision. In some embodiments, the method further comprises maintaining a pre-collision thrust in the aerial vehicle during the collision and generating a new thrust to stabilize the aerial vehicle after the collision.

Consistent with the disclosed embodiments, an apparatus comprises an aerial vehicle including an arm including a flexible member having a length. The apparatus comprises a sensing system included in the aerial vehicle, the sensing system to detect a change in the length resulting from a mid-air collision and to generate a collision signal. The apparatus comprises a controller to receive the collision signal and execute a collision recovery operation for the aerial vehicle in which the aerial vehicle sustains and resumes flight following the mid-air collision. In some embodiments, the arm includes a prismatic joint.

Consistent with the disclosed embodiments, a method comprises receiving a collision signal after deformation of a collision-resilient robot from a collision. The method comprises recovering control of the collision-resilient robot after the collision. And the method comprises planning a post-collision trajectory for the collision-resilient robot using a global search-based planner. In some embodiments, recovering control of the collision-resilient robot after the collision comprises, for the collision-resilient robot having an orientation after the collision, maintaining the orientation throughout the collision recovery process. In some embodiments, planning the post-collision trajectory for the collision-resilient robot after the collision using the global search-based planner comprises using a post-collision state determined while recovering control of the collision-resilient robot after the collision as the initial state for post-collision trajectory generation. In some embodiments, planning the post-collision trajectory for the collision-resilient robot after the collision using the global search-based planner comprises, for the collision-resilient robot having a collision state, planning the post-collision trajectory when there is no direct line of sight between the collision state and a waypoint at an end of an immediately next trajectory segment following collision recovery.

Consistent with the disclosed embodiments, a collision resilient robot comprises a processor. The processor is configured to receive a collision signal after deformation of the collision-resilient robot from a collision. The processor is configured to recover control of the collision-resilient robot after the collision. And the processor is configured to plan a post-collision trajectory for the collision-resilient robot using a global search-based planner. In some embodiments, the collision signal is generated from a sensor embedded between a main chassis and a deflection surface of the collision resilient robot. In some embodiments, the global search-based planner uses information from the sensor to plan a post-collision trajectory for the collision-resilient robot. In some embodiments, the collision resilient robot of claim 30, wherein the collision-resilient robot has a field of view and the global search-based planner evaluates possible collisions within the field of view and outside the field of view to plan the post collision trajectory. In some embodiments, the global search-based planner adjusts one or more waypoints of a preplanned trajectory with information obtained from the collision to generate the post-collision trajectory plan. In some embodiments, the global search-based planner evaluates effects of possible collisions and determines when a preferred post-collision trajectory is to collide with a surface instead of avoiding the surface. In some embodiments, the collision resilient robot further comprises an arm to couple a main chassis of the collision resilient robot to a deflection surface.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 shows a block diagram of an apparatus including an arm and sensing system for use in an aerial vehicle in accordance with some embodiments of the present disclosure;

FIG. 2 shows an illustration of the apparatus shown in FIG. 1 in accordance with some embodiments of the present disclosure;

FIG. 3A shows an illustration of the apparatus shown in FIG. 1 before a collision along the longitudinal axis of the flexible member of the arm in accordance with some embodiments of the present disclosure;

FIG. 3B shows an illustration of the apparatus shown in FIG. 1 after a collision along the longitudinal axis of the flexible member of the arm in accordance with some embodiments of the present disclosure;

FIG. 4 shows an illustration of an apparatus including an aerial vehicle including the arm, also shown in FIG. 1, and a sensing system in accordance with some embodiments of the present disclosure;

FIG. 5 shows a flow diagram of a method for detecting a collision of an aerial vehicle in accordance with some embodiments of the present disclosure;

FIG. 6 shows an illustration one embodiment of a working prototype of the aerial vehicle shown in FIG. 4 in accordance with some embodiments of the present disclosure;

FIGS. 7A-7D show illustrations of photos of instances a quadrotor detecting and recovering from passive collisions in FIG. 7A and FIG. 7B and from a collision with a vertical wall in FIG. 7C and FIG. 7D in accordance with some embodiments of the present disclosure;

FIG. 8 shows a quadrotor model coordinate system in accordance with some embodiments of the present disclosure;

FIG. 9 shows a block diagram of the software architecture for the quadrotor in accordance with some embodiments of the present disclosure;

FIG. 10 shows a characterization of a collision vector CB in accordance with some embodiments of the present disclosure;

FIG. 11 shows a quadrotor hovering while attached to a safety tether in accordance with some embodiments of the present disclosure;

FIGS. 12A-12D show a series of illustrations of snapshots of the quadrotor detecting and recovering from a passive collision with FIG. 12A the quadrotor hovering FIG. 12B the collision starting and the arm absorbing the shock FIG. 12C the recovery control starting with a passive body morphing in the air, and FIG. 12D the quadrotor stabilized and hovering after recovery from the passive collision in accordance with some embodiments of the present disclosure;

FIG. 13 shows state tracking in passive collision recovery where the x-axis points to the North, the y-axis points to the West, and the origin is located at the quadrotor's takeoff position in accordance with some embodiments of the present disclosure;

FIGS. 14A-14F show a quadrotor recovering from a wall collision with a single arm in contact at a collision speed of 2.58 m/s and a collision intensity of with the collision starting at t=0 ms in FIG. 14A, the arm absorbing the shock and the robot coming to a full stop at t=32 ms in FIG. 14B the quadrotor tracking a smooth trajectory for recovery in FIGS. 14C-14E, and the quadrotor stabilized and hovering again at t=3,816 ms in FIG. 14F in accordance with some embodiments of the present disclosure;

FIGS. 15A-15B show a quadrotor detecting and recovering from a pole collision with the speed of 2.04 m/s in FIG. 15A and a collision intensity of 0.20 in FIG. 15B in accordance with some embodiments of the present disclosure;

FIGS. 16A-16D show a quadrotor detecting and recovering from collision with an unstructured surface with a speed of 1.95 m/s in accordance with some embodiments of the present disclosure;

FIGS. 17A-17D show a drop test for a quadrotor at a height of 1.8 m with a maximum velocity of 5.9 m/s in accordance with some embodiments of the present disclosure;

FIG. 18 shows an overview of a unified framework for collision inclusive motion planning and control and builds upon two novel components—a global collision-inclusive planner and a local trajectory generator in accordance with some embodiments of the present disclosure;

FIG. 19 shows a DRR strategy for a low-level planner in accordance with some embodiments of the present disclosure;

FIG. 20 shows at the left a model of a wheeled robot equipped with compliant arms and a close=up view of the assembly of a visco-elastic prismatic joint and Hall effect sensor in accordance with some embodiments of the present disclosure;

FIGS. 21A-21B show waypoint adjustment process when a collision is sensed in accordance with some embodiments of the present disclosure;

FIG. 22 shows an example of performing collision and detouring away from a convex obstacle by generating a new waypoint among the point of collision and the goal in accordance with some embodiments of the present disclosure;

FIGS. 23A-23B show composite images of a sample experiment using a DRR strategy with a robot moving from start to goal passing through all waypoints, including intermediate ones created post-collision, with snapshots shown every 2 seconds in accordance with some embodiments of the present disclosure;

FIGS. 24A-24D show experimental trajectories generated from DRR and collision avoidance trajectory generation strategy when a preplanned path intersects or does not intersect with an obstacle in accordance with some embodiments of the present disclosure;

FIGS. 25A-25F show comparisons between a search-based collision avoidance global planner and a search-based collision inclusive global planner for two different p_{c} values with higher p_{c} values leading to penalizing collisions more with recovering behaviors that resemble collision avoidance in accordance with some embodiments of the present disclosure;

FIGS. 26A-26H show computational time, path length, trajectory time and control energy metrics for collision-avoidance (CA) without and with noise and collision-inclusive (CI) without and with noise frameworks, for two cases of replanning time Trep=5:0 s and Trep=10:0 s in accordance with some embodiments of the present disclosure;

FIG. 27 shows success rates of both collision-avoidance and collision-inclusive frameworks in accordance with some embodiments of the present disclosure;

FIGS. 28A-28F show simulated trajectories of a unified collision-inclusive motion planning and control framework with online sensing and noise added to the input of the global planner in a double corridor environment with increasing obstacle density in accordance with some embodiments of the present disclosure;

FIG. 29 shows composite images of a sample experiment with a unified collision-inclusive motion planning and control framework and of a collision avoidance sample experiment with snapshots shown every 2:5 seconds in accordance with some embodiments of the present disclosure;

FIGS. 30A-30B show experimental trajectories generated from a collision-inclusive method and the collision avoidance method in accordance with some embodiments of the present disclosure;

FIG. 31 shows an illustration of a collision-resistant robot in accordance with some embodiments of the present disclosure; and

FIG. 32 shows a flow diagram of a method in accordance with some embodiments of the present disclosure.

### DESCRIPTION

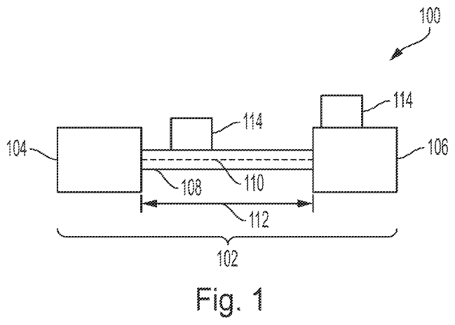

FIG. 1 shows a block diagram of an apparatus 100 for use in an aerial vehicle in accordance with some embodiments of the present disclosure. The apparatus 100 includes an arm 102 and a sensing system 114. The arm 102 includes a first substrate 104, a second substrate 106, and a flexible member 108.

The flexible member 108 couples the first substrate 104 to the second substrate 106. The flexible member 108 has a longitudinal axis 110 and a length 112. The flexible member 108 provides flexibility for the arm 102 along the longitudinal axis 110. The flexible member 108 returns to a resting length after the force causes compression of the flexible member 108 is removed. The flexible member 108 is not limited to a particular type of mechanical structure. In some embodiments, the flexible member 108 includes a prismatic joint. A prismatic joint is a coupling between two objects that allows one passive degree of freedom along a single axis. In operation, with the arm 102 including the flexible member 108 included in an aerial vehicle, the arm 102 allows compression of the flexible member 108 along the longitudinal axis 110 during a collision of the aerial vehicle. Compression of the flexible member 108 results in a change in the length 112 of the flexible member 108 and the distance between the first substrate 104 and the second substrate 106.

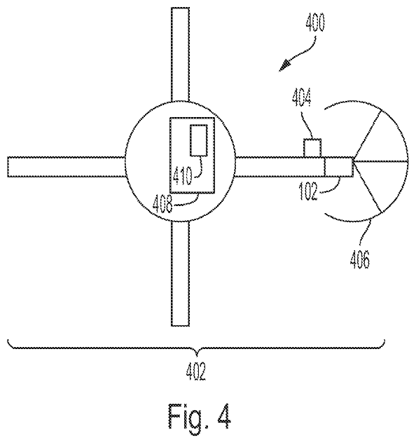

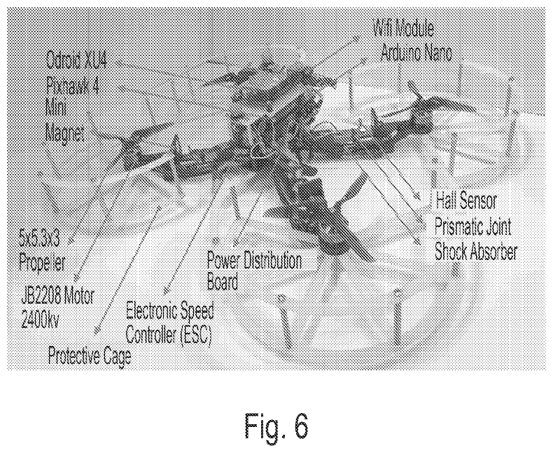

In some embodiments, the first substrate 104 and the second substrate 106 along with the flexible member 108 are a standalone unit that can be incorporated into the airframe of an aerial vehicle as shown in FIG. 4. In some embodiments, the first substrate 104 is designed to couple to the airframe of an aerial vehicle and the second substrate 106 is designed to couple to a protective structure, such as the protective cage shown in FIG. 6. In some embodiments, the first substrate 104 is provided by the airframe of the aerial vehicle and the flexible member 108 is coupled directly to the airframe. In operation, with the arm 102 included in an aerial vehicle, the second substrate 106 couples mechanical energy resulting from a collision of the aerial vehicle to the flexible member 108.

The sensing system 114 is mounted on the arm 102. In some embodiments, the sensing system 114 includes a signal source mounted on the first substrate 104 and a signal detector mounted on the flexible member 108. In some embodiments, the signal source includes a magnet, and the signal detector includes a Hall-effect sensor. In operation, with the arm 102 included in an aerial vehicle, the sensing system 114 detects a change in the magnetic field at the Hall-effect sensor that results from a change in the length 112 of the flexible member 108 triggered by a collision of the aerial vehicle that results in compression of the flexible member 108.

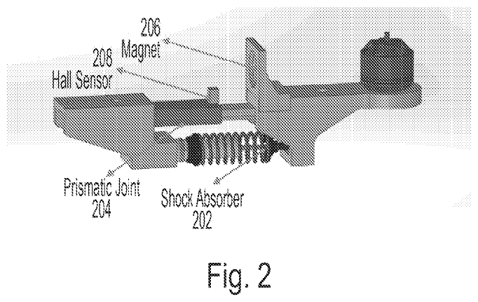

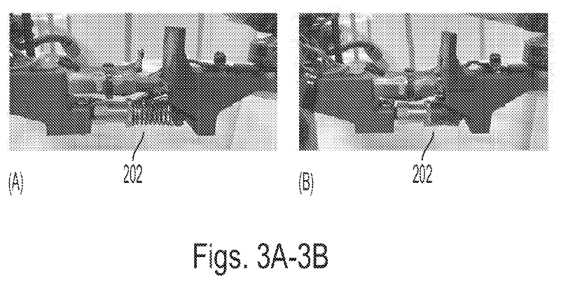

FIG. 2 shows an illustration of one embodiment of the arm 102 (shown in FIG. 1) in accordance with some embodiments of the present disclosure. The flexible member 108 (shown in FIG. 1) includes a shock absorber 202. The shock absorber 202 is a device for absorbing energy of a sudden impulse that occurs in a collision between the arm 102 included in an aerial vehicle and another object. In some embodiments, the shock absorber 202 is a spring. In operation, with the arm 102 included in an aerial vehicle, the spring constant is selected in ensure that the arm 102 retains rigidity during free flight of the aerial vehicle in the absence of a collision. Referring to FIG. 3, FIG. 3A shows the arm 102 including the shock absorber 202 uncompressed before a collision and FIG. 3B shows the arm 102 including the shock absorber 202 compressed during a collision.

FIG. 4 shows an illustration of an apparatus 400 including an aerial vehicle 402 including the arm 102, also shown in FIG. 1, and a sensing system 404 in accordance with some embodiments of the present disclosure. The arm 102 includes the flexible member 108 (shown in FIG. 1) having the length 112 (shown in FIG. 1). In some embodiments, the sensing system 404 includes the sensing system 114 (shown in FIG. 1). In operation, the sensing system 404 detects a change in the length 112 (shown in FIG. 1) of the flexible member 108 (shown in FIG. 1) of the arm 102 that occurs during a collision of the aerial vehicle 402.

The aerial vehicle 402 is not limited to a particular category of aerial vehicles. In some embodiments, the aerial vehicle 402 is an unmanned aerial vehicle such as those used for search and rescue, surveillance, and commercial applications. In some embodiments, the aerial vehicle 402 is a quadrotor—an unmanned aerial vehicle including four rotors. In some embodiments, the aerial vehicle 402 includes a protective structure 406 mechanically coupled to the arm 102. In operation, the protective structure 406 reduces the harmful effects of collisions on the aerial vehicle 402.

The sensing system 404 is not limited to a particular type of sensing system. In some embodiments, the signal source in the sensing system 404 is a magnet, such as the magnet 206 shown in FIG. 2, and the detector is a Hall effect sensor, such as the Hall-effect sensor 208 shown in FIG. 2. As can be seen in FIG. 2, the magnet 206 and the Hall effect sensor 208 are positioned on the arm 102 such that the Hall effect sensor 208 experiences a change in the magnetic field as the length 112 (shown in FIG. 1) of the flexible member 108 (shown in FIG. 1) changes. The Hall-effect sensor 208 is communicatively coupled to a processor 408. In operation, during a collision of the aerial vehicle 402, the Hall-effect sensor 208 detects a change in the magnetic field provided by the magnet 208 as the length 112 (shown in FIG. 1) of the flexible member 108 (shown in FIG. 1) included in the arm 102 changes and provides a collision detection signal to the processor 408.

As shown in FIG. 2, the arm 102 includes a shock absorber 202. In some embodiments, the shock absorber 202 includes a passive spring. In operation, with the arm 102 shown in FIG. 2 included in the aerial vehicle 402, the shock absorber 202 is adjusted such that the length 112 of the flexible member 108 remains substantially unchanged during free flight of the aerial vehicle 402.

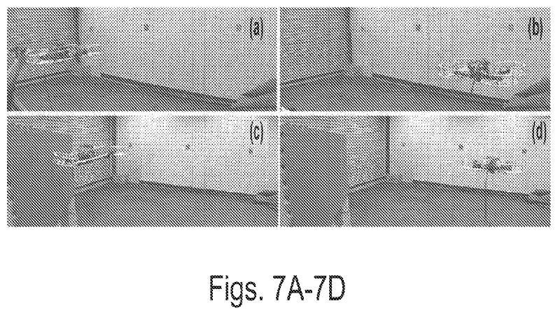

Referring again to FIG. 4, in some embodiments, the aerial vehicle 402 includes a collision recovery control system 410 communicatively coupled to the sensing system 404. The collision recovery control system 410 includes a single stage collision recovery control system. The collision recovery control system 410 enables the aerial vehicle 402 to sustain flight after a collision with a variety of objects including walls, poles and unstructured obstacles, or after a collision with a moving object while the aerial vehicle 402 is hovering as shown in FIG. 7.

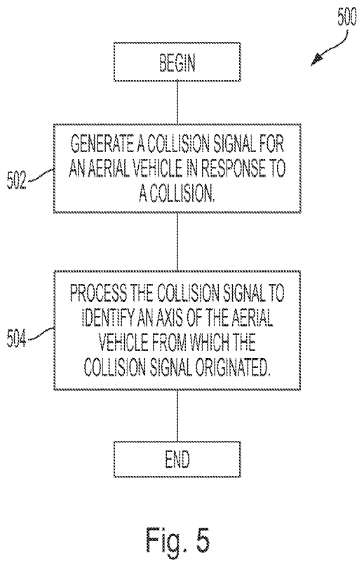

FIG. 5 shows a flow diagram of a method 500 for detecting a collision of an aerial vehicle in accordance with some embodiments of the present disclosure. The method 500 includes generating a collision signal for an aerial vehicle in response to a collision (block 502), and processing the collision signal to identify an axis of the aerial vehicle from which the collision signal originated (block 504).

In some embodiments, generating the collision signal for the aerial vehicle in response to the collision includes detecting compression of an arm of the aerial vehicle. In some embodiments, generating the collision signal for the aerial vehicle in response to the collision includes processing a Hall effect sensor signal generated from a change in a length of a flexible member included in the aerial vehicle. In some embodiments, generating the collision signal for the aerial vehicle in response to the collision includes detecting the collision without inertial measurement data.

In some embodiments, the method 500 further includes estimating deformation of the aerial vehicle resulting from the collision.

In some embodiments, the method 500 further includes processing the collision signal to identify an intensity of the collision. In some embodiments, the method further includes recovering from the collision. In some embodiments, recovering from the collision includes recovering from a wall collision. In some embodiments, recovering from the wall collision comprises minimizing the snap trajectory generation. In some embodiments, recovering from the wall collision comprises recovering from the wall collision where the aerial vehicle had a velocity of about 5.9 meters per second at a time slightly before the collision. In some embodiments, the method further includes maintaining a pre-collision thrust during the collision and generating a new thrust to stabilize the aerial vehicle after the collision.

In some embodiments, a method includes generating a collision signal from compression of a flexible member resulting from a mid-air collision of an aerial vehicle including the flexible member and processing the collision signal and initiating execution of a recovery operation to sustain and resume flight of the aerial vehicle following the mid-air collision. In some embodiments, processing the collision signal and initiating execution of the recovery operation to sustain and resume flight of the aerial vehicle following the mid-air collision includes processing the collision signal to identify an intensity of the mid-air collision. In some embodiments, the method further includes maintaining a pre-collision thrust in the aerial vehicle during the collision and generating a new thrust to stabilize the aerial vehicle after the collision.

### Hardware and Software Design of Quadrotor

FIG. 6 shows one embodiment of a working prototype of the aerial vehicle 402 shown in FIG. 4 in accordance with some embodiments of the present disclosure. The embodiment shown is a quadrotor constructed from off-the-shelf components and custom 3D-printed parts. To embrace collision and enable recovery, each arm of quadrotor integrates a shock absorber and Hall-effect sensor.

The following components are included in the working prototype: Wi-Fi Module, Arduino Nano (for analog to digital conversion), Magnet, Hall Sensor, Prismatic Joint, Shock Absorber, Odroid XU4 (with ROS environment as the companion computer), Pixhawk 4 Mini (flight controller with the open-source PX4 autopilot), Power Distribution Board, Electronic Speed Controller, 5×5.3×3 Propeller, JB 2208 Motor—2400 k, Protective Cage (nylon).

### Electro-Mechanical Hardware Prototyping

The components of the quadrotor center on the quadrotor's compliant arm design and the integration of Hall sensors to estimate deformation resulting from a collision.

1) Compliant Arm Design: Unlike existing resilient flying robots whose physical configurations are drastically changed after collision, the configuration of quadrotor remains the same before and immediately after the collision. This key property makes the quadrotor an appropriate platform to conduct complex tasks that require model-based control. To meet this end, the design retains rigidity when in free flight while allowing for one passive degree of freedom in the direction along each arm.

The computer-aided design (CAD) assembly and main components of arm 102 are shown in FIG. 2. The prismatic joint 204 is built based on a solid brass 2-inch surface bolt. The bolt is covered by heat-shrinkable tubes to reduce the free space within the joint. The aluminum shock absorber 202 was taken from 1/18 radio-control cars. An A1302 ratio metric linear Hall-effect sensor is fixed on the prismatic joint 204 to measure the magnetic intensity. The adapters connecting the prismatic joint 204 and shock absorber 202 are 3D-printed Markforged Mark II, onyx material with carbon fiber add-in.

A close-up view of an arm 102 of the quadrotor before and during collision is shown in FIG. 3. The arm 102 successfully addresses the challenge that the frame remains rigid during regular flight while it can absorb harmful impacts from collision.

2) Hall Sensor: The ability to detect and characterize collisions is critical to stabilize quadrotors and sustain flight. Existing collision-detection methods with inertial measurement units (IMUs) require detailed modeling of the environment and obstacles, which limits application in unknown environments. In this disclosure, the Hall-effect sensor 208 is adopted for collision detection.

Hall-effect sensors are commonly used to measure the magnitude of a magnetic field. The sensor's output voltage is directly proportional to the magnetic field strength through the sensor. In the disclosed prototype, A1302 ratiometric linear Hall-effect sensors are fixed on the prismatic joints, coming in contact with the magnet when the length of a shock absorber reduces to its minimum length (FIG. 3). Despite the relatively close distance, the rotating motors were observed to have almost no effect on the Hall-effect sensor's readings. Hall-effect sensors and embedded magnets do not affect the IMU performance in the flight control unit as well.

Using one sensor per arm 102 allows determination of whether the quadrotor is in contact with an obstacle or not, and gives an approximation of the collision intensity. By utilizing four Hall-effect sensors, the quadrotor can approximate where the collision occurs in the body frame.

### Modeling and Control

1) Notation: A world frame W is used with orthonormal basis

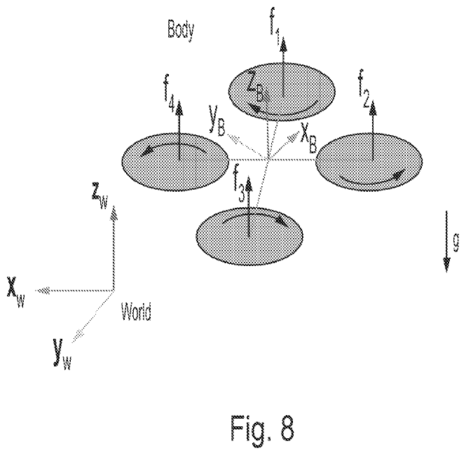

{x_{W}, y_{W}, z_{W}} and a body frame B with orthonormal basis {x_{B}, y_{B}, z_{B}}. The body frame is fixed to the quadrotor with the origin located at the center of mass (FIG. 8). The position, velocity and acceleration of the quadrotor's center of mass are denoted by
∈ [symbol] ³, V∈ [symbol] ³
and
a∈ [symbol] ³,
   respectively. Vector subscripts denote the frame the vector is expressed at, for example, x_{B} represents the position in the body frame. Vectors without subscript are expressed in the world frame. R_{W}^{B} denotes a rotation matrix from the body frame to the world frame. For clarity, the remainder of the description uses R to represent R_{W}^{B}. The subscript d denotes a desired value.

2) Model: The quadrotor equations of motion are

\dot{x}=v (1)

m\dot{v}=mge₃+fRe₃ (2)

\dot{R}=R\hat{Ω} (3)

j\dot{Ω}+Ω×JΩ=M (4)

where m is the mass and g is the gravitational acceleration constant. Unit vector e₃ represents the direction of gravity in the world frame. Ω denotes the angular velocity in the body frame, and \hat{Ω} is the skew-symmetric matrix representation of Ω, f and M=[M1 M2 M3]^{T} are the force and torque control inputs. The required thrust of each rotor fᵢ can be determined by solving the system of equations

$$[ \begin{matrix}\begin{matrix}\begin{matrix}f \\ {M}_{1}\end{matrix} \\ {M}_{2}\end{matrix} \\ {M}_{3}\end{matrix} ] = [ \begin{matrix}1 & 1 & 1 & 1 \\ 0 & - l & 0 & l \\ l & 0 & - l & 0 \\ - {c}_{f} & {c}_{f} & - {c}_{f} & {c}_{f}\end{matrix} ] [ \begin{matrix}\begin{matrix}\begin{matrix}{f}_{1} \\ {f}_{2}\end{matrix} \\ {f}_{3}\end{matrix} \\ {f}_{3}\end{matrix} ] \qquad ( 5 )$$

where l is the length of the arm and c_{f} is the fixed constant for thrust generation.

When a collision happens, the arm length l will be reduced, therefore altering the required thrust (5). However, by taking advantage of Hall sensors, the quadrotor can wait until an elastic collision has been terminated, recovering arm length l and hence the system of equations to find the thrust for each motor. In the waiting time to recover the original arm length (less than one second), the fight control unit computes rotor thrusts according to the original arm length l and the motors continue rotating.

3) Controller: A geometric tracking controller is deployed for quadrotors. Control inputs f, M are chosen as

f=−(−kₓeₓ−kᵥeᵥ−mge₃+m\ddot{x}_{d})·Re₃ (6)

M=−k_{R}e_{R}−k_{Ω}e_{Ω}+Ω×JΩ−J(\hat{Ω}R^{T}R_{d}Ω_{d}−R^{T}R_{d}\dot{Ω}_{d}) (7)

Tracking errors are given by

eₓ=x−x_{d} (8)

eᵥ=v−v_{d} (9)

e_{R}=½(R_{d}^{T}R−R^{T}R_{d})^{∨} (10)

e_{Ω}=Ω−R^{T}R_{d}Ω_{d} (11)

where the vee map ∨ is the inverse of a skew-symmetric mapping.

### Software Architecture

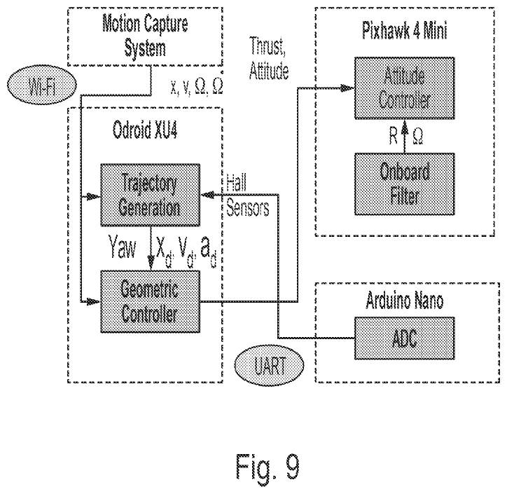

The software was developed in C++ using the ROS framework (FIG. 9). The flight controller Pixhawk 4 Mini, companion computer Odroid XU4 and the Arduino Nano are all mounted on the quadrotor (FIG. 6). The Odroid runs Ubuntu 16.04 LTS and communicates with a 12-camera VICON motion capture system server over Wi-Fi for odometry feedback.

Three nodes are running within the Odroid. The first one is the MAVROS node to communicate with the PX4 firmware in Pixhawk via MavLink. The second node is the trajectory generation node. The trajectory generation node outputs the desired position, velocity, acceleration, yaw, and yaw rate to the geometric controller node. Finally, the controller node calculates and sends the desired thrust and attitude to the flight controller.

The Pixhawk 4 Mini runs in offboard mode. The inbuilt MAVROS function setpoint raw/attitude is called at 50 Hz to set motors commands according to the given thrust and attitude data. The Pixhawk runs an internal extended Kalman filter (EKF) to fuse IMU data and estimate the quadrotor's pose and orientation.

One Arduino Nano connects four Hall sensors and converts the analog signals to digital ones. The Arduino sends digital readings to the Odroid via UART at 200 Hz for collision detection and characterization.

### Collision Detection and Characterization

The Hall-effect sensor outputs a voltage proportional to the magnetic field strength through it. The magnet is positioned at one side of the shock absorber and the Hall-effect sensor is positioned at the other end (FIG. 3). At the time of a collision, the contact force shortens the spring in the absorber, thereby reducing the distance between a Hall-effect sensor with a magnet, thus increasing the output voltage recorded in the Arduino.

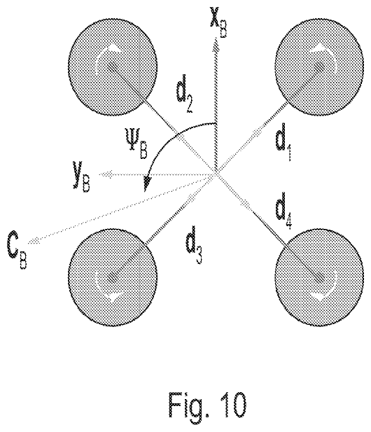

FIG. 10 illustrates how the quadrotor estimates the location and intensity of a collision C_{B} in the body frame. There are four vectors dᵢ that represent the collision detected by the Hall-effect sensors along the arms. Let dᵢ∉[0,1], i=1, 2, 3, 4 denote values from the analog to digital conversions, where dᵢ=0 means no contact force is detected and dᵢ=1 indicates that the minimum length of the shock absorber has been reached.

To estimate the intensity and location of the collision C_{B}, the magnitude of C_{B} needs to be calculated and orientation Ψ_{B}∉[−π, π] (positive orientation corresponds to counterclock direction). First, all vectors dᵢ are projected onto the basis x_{B} and y_{B} with d_{i,x}, d_{i,y}. For example, the projections of d₁ can be written as

$${d}_{1 , x} = {d}_{1} cos \frac{θ}{2} \qquad ( 12 )$$

$${d}_{1 , y} = - {d}_{1} sin \frac{θ}{2} \qquad ( 13 )$$

where θ=∠(d₁, d₂) represents the angle between the vectors d₁ and d₂. After adding up all projections, the collision can be characterized as follows

$${d}_{x} = {\sum }_{i = 1}^{4} {d}_{i , x} \qquad ( 14 )$$

$${d}_{y} = {\sum }_{i = 1}^{4} {d}_{i , y} \qquad ( 15 )$$

$${C}_{B} = \sqrt{{d}_{x}^{2} + {d}_{y}^{2}} \qquad ( 16 )$$

$${Ψ}_{B} = atan 2 ( {d}_{y} , {d}_{x} ) \qquad ( 17 )$$

An effective collision detection requires both accuracy and an appropriate time of detection t_{d} to initiate recovery control. Unlike existing methods that often rely on certain thresholds to decide on collision occurrence and detection time, detection herein is based on an algorithm to measure the maximum collision intensity and time t_{d}.

The algorithm initiates with zero for the maximum collision intensity C_{B} and false for the collision detection flag. While there is no collision detected, the loop reads data from the Hall-effect sensors at the current time j and calculates C_{B,j} and Ψ_{B;j} as discussed previously. When a collision intensity greater than 0.1 is detected, the loop compares the current collision magnitude with the maximum one and saves the value if the current collision magnitude is greater. After a maximum collision magnitude is found, the algorithm starts counting for the loop and sets the collision flag true after N loops afterward, where N is selected so that t_{d} is close to the time when the lengths of the arms recover to satisfy the nominal length dynamic model.

### Recovery Control

Existing work in recovery control uses different stages to track, resulting in discontinuities in the overall trajectory. The disclosed recovery controller does not have multiple stages, leading to a smooth desired trajectory to track. This single-stage control design can improve the robustness of the recovery and be suitable to apply to collisions with a variety of objects such as walls and poles.

A minimum-snap trajectory generation is disclosed. Minimum-snap polynomial splines can be effective for quadrotor trajectory planning since the motor commands and attitude accelerations of the vehicle are proportional to the snap of the path. Minimizing the snap of a trajectory can maintain the quality of onboard sensor measurements while avoiding abrupt or excessive control inputs.

After a collision occurs, the quadrotor is made to return to a position x_{d} that is in the opposite direction of the collision at a distance proportional to the collision intensity. The recovery position x_{d} is constrained to be at the same height as the collision position. Thus, the desired position is found in the body frame x_{d,B} as

$${x}_{d , B} = Rot ( z , {Ψ}_{B} ) [ \begin{matrix}\begin{matrix}- {C}_{B} \\ 0\end{matrix} \\ 0\end{matrix} ] \qquad ( 18 )$$

where Rot(z. Ψ_{B}) is the rotation matrix along the z-axis by angle Ψ_{B}. Then, x_{d} is calculated in the world frame by

x_{d}=R^{T}x_{d,B} (19)

For the flat output variables x, y, z and yaw angle, the yaw angle is fixed and only consider x=[xyz]^{T}. A single trajectory segment between two points is composed of independent polynomials P(t) for x. A cost function penalizes the squares of fourth-order derivatives of P(t) as:

J=∫₀^{T}c₄P⁽⁴⁾(t)²dt=p^{T}Qp (20)

In the expression, p is a vector of the N=10 coefficients of a single polynomial. Only the fourth-order derivative of P(t) is involved in the cost function in order to minimize snap. The construction of the Hessian matrix Q is known to those skilled in the art. In sum, the optimization is formulated as:

$${minimize}_{p} J = {p}^{T} Qp \qquad ( 21 )$$

$$subject to Ap = b$$

In this optimization, the constraint Ap=b imposes the endpoint constraints that x(0)=x₀, \dot{x}(0)=v₀, x(T)=x_{d} where x₀, v₀ are the position and velocity of the quadrotor when collision happens and T is estimated based on the maximum acceleration and velocity. The velocity and acceleration at t=T are set to zero. Note the acceleration is not commanded at time t=0 since the feedback from the motion capture system has no acceleration data.

### EXPERIMENTS AND RESULTS

The collision-resilient performance of quadrotor was evaluated through five experiments: passive collision, wall collision, pole collision, colliding with unstructured surfaces, and free fall.

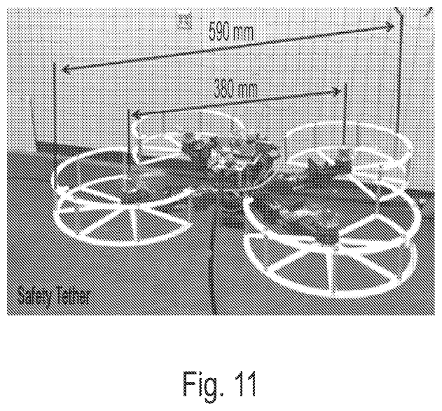

The quadrotor used in these experiments measured 380 mm from propeller tip-to-tip and 590 mm from protection cage tip-to-tip. A 3500 mAh 3-cell LiPo battery was used to power the quadrotor. The quadrotor weighed 1.419 kg with the battery and had a maximum thrust-to-weight ratio of 4.58. The average energy efficiency was 2.2 g/W. During the experiments, the actual thrust-to-weight ratio was limited to 2 by reducing the maximum pulse width modulation (PWM) values. A safety tether was connected the robot to prevent damages in case of losing control (FIG. 11). The safety tether was lightweight, and had no observable impact on the test flights. The quadrotor was manually commanded to take off in stabilized mode and then switched to the offboard mode to let it hover before tests. When tests were done, the robot was switched back to stabilized mode again to manually land.

### A. Passive Collision

Existing work on collision detection and recovery assumes that the quadrotor operates within a static environment. In other words, the robot is the only moving object within the environment. However, as UAVs are tasked to explore more dynamic environments, the quadrotor can be hit by an obstacle when it is hovering. This type of collision as a passive collision.

Surviving passive collisions is challenging to the quadrotor because such type of collision is almost undetectable by using IMU data alone. There is no change in IMU readings before the collision happens, therefore all IMU based methods will fail in this case. Similarly, vision-based resilience is very likely to fail as well unless the colliding object is right inside the camera field of view and can be detected fast enough.

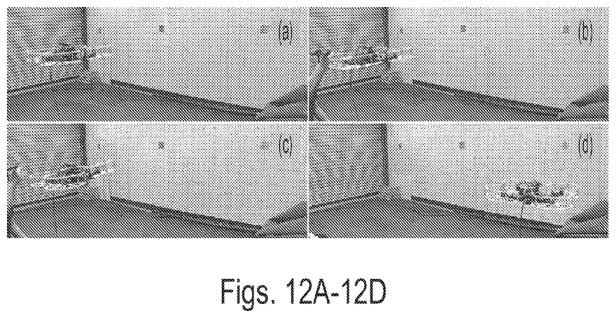

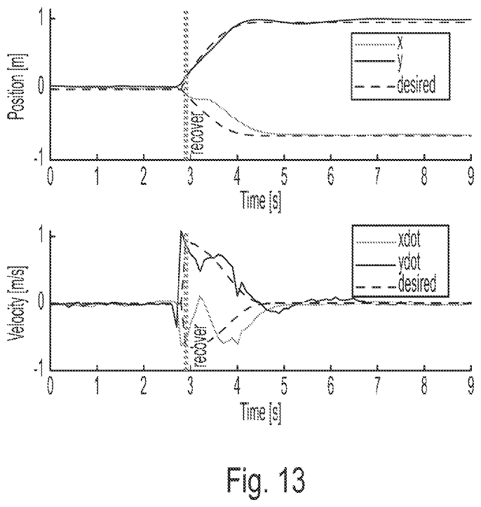

The quadrotor can handle passive collisions because the Hall sensors provide rapid collision detection while hovering. In the test, the quadrotor was hit along the direction of an arm while it was hovering. The recovery process is shown in FIG. 12. Results demonstrate that ARQ can sustain flight after being passively hit at a collision speed of 1.3 m/s, which is the vehicle's translational velocity after the collision with no rotational movements. The states and desired states were tracked during the passive collision recovery in FIG. 13 where the positions and velocities along the x-axis and y-axis are plotted. The desired values are plotted in dashed curves. A vertical black dotted line represents the time when the recovery controller was triggered.

After the collision is detected and characterized, the quadrotor calculates a smooth stabilizing trajectory, the initial velocities of which match the velocities when recovery control begins. The geometric controller commands the quadrotor to track the desired trajectory. However, irregular changes in velocities were observed due to the body morphing (FIG. 12C). Body morphing delays trajectory tracking in the x direction; however, the quadrotor can still converge to desired states quickly and sustain stable flight. Low tracking errors shown in FIG. 13 indicate that the quadrotor arms remain substantially rigid during free flight.

### B. Wall Collision

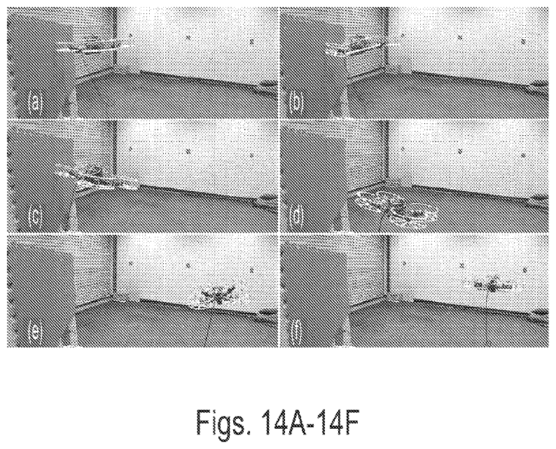

In the wall test, a vertical wooden wall was covered by the EVA foam sheet in front of the quadrotor (FIG. 14). The same steps to take off and hover were followed with the geometric controller. The quadrotor was then commanded to follow a trajectory that intersects with the wall. The position of the wall was entirely unknown to the robot before the collision.

FIG. 14 shows results of a wall collision with a single arm. The quadrotor detected the wall accurately and quickly, then recovered from the collision with a speed of up to 2.58 m/s and sustain flight afterward, which is greater than the maximum feasible velocities 1.0 m/s in and 2.0 m/s. The collision resilience to a vertical wall was investigated with two arms in contact as well. Results validate that the quadrotor can estimate the intensity and orientation of two-arm collision accurately based on four Hall sensors and sustain stable flight with a collision speed of 2.08 m/s.

To clearly demonstrate the individual contribution of compliance and recovery control components, two additional wall tests were conducted with a collision speed of 2.3 m/s. In the first test, the arms remained compliant but the recovery controller was disabled. In the second test, the arms were fixed in place using custom jigs (these added 25 g of weight to the robot) while the recovery controller was disabled. Experimental trials showed that compliance alone can reduce collision impact, but cannot help sustain fight; the robot falls to the ground after getting stuck to the wall for several seconds because of lack of recovery control. In the second test, a worse impact was observed which makes the robot fall to the ground immediately. The two tests showed that compliance can reduce detrimental impacts from collisions while recovery control is essential to sustain fight afterward.

### C. Pole Collision

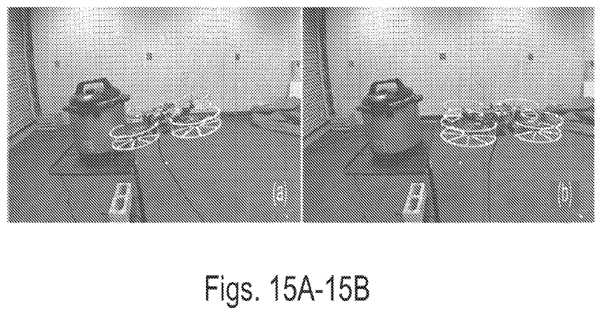

The quadrotor's capability of recovering from a collision with a cylindrical/pole-like object was demonstrated. The cylinder had a diameter of 300 mm. FIG. 15 shows an illustration derived from a snapshot colliding with the cylinder at a speed of 2.04 m/s.

Results demonstrate that the quadrotor can accurately detect pole collisions. The recovery process was very similar to the one with vertical walls, except the collision intensity (0.20) is much smaller, due to the shape of the obstacle. The recovery controller stabilized the robot with a hovering position close to the obstacle (FIG. 15B). The recovery does not have multiple discontinuous phases, and the robot tracked a smooth trajectory throughout the recovery.

### D. Unstructured Surface Collision

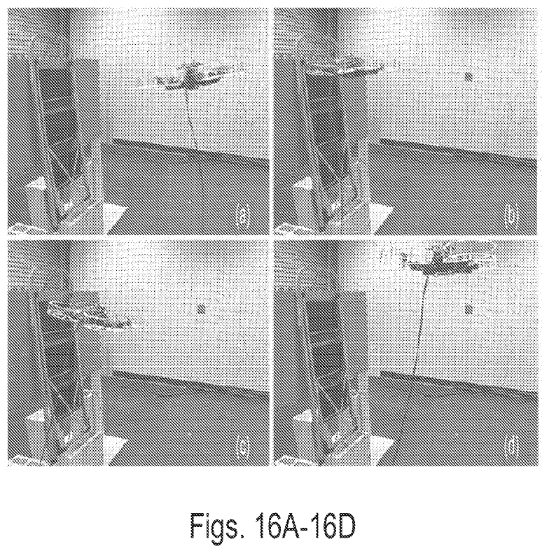

Unlike existing IMU-based methods, the quadrotor does not require prior knowledge of collision models to handle collisions. A collision test on an unstructured surface was performed to demonstrate this property. A metal folding step ladder was placed along a wall (FIG. 16).

The quadrotor was commanded to hit the unstructured surface with a collision speed of 1.95 m/s. The process is illustrated in FIG. 16. Following a smooth desired trajectory after the collision, the quadrotor stabilized itself and returned to the hovering state. The quadrotor's ability to survive a collision with the unstructured surface is key for UAVs to be deployed in unknown environments.

### E. Free Fall

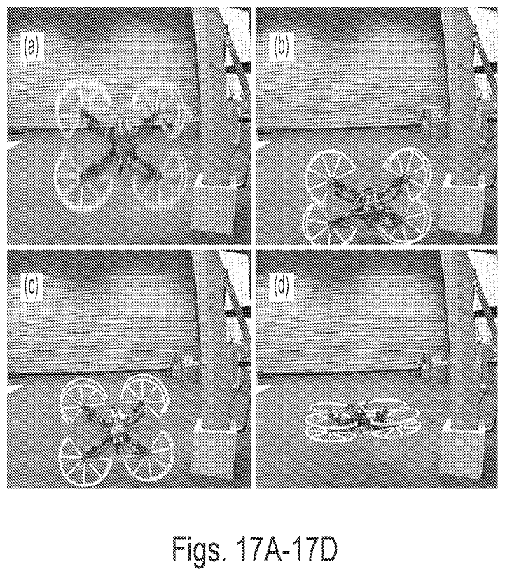

To better demonstrate the benefit of adding compliance, a free fall test with ARQ (FIG. 17) was conducted. The test was conducted without the battery. The quadrotor, without the battery, weighs 1.12 kg. The quadrotor was found to survive free falls from 1.8 m high. The quadrotor reached a maximum velocity of 5.9 m/s. There was no damage to the quadrotor.

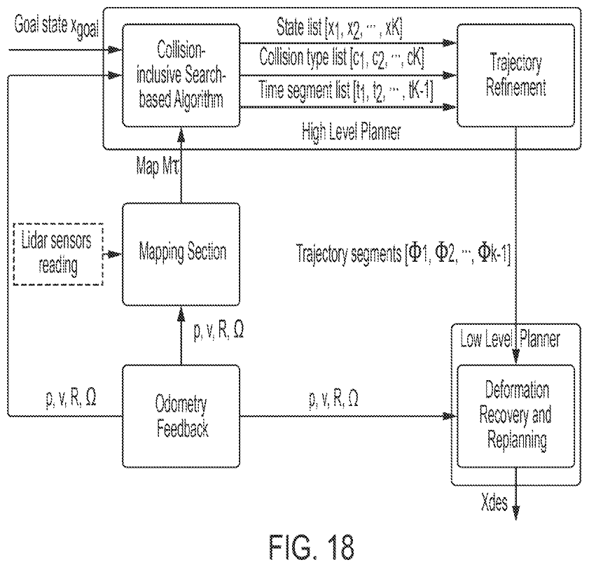

FIG. 18 shows an overview of a unified framework for collision inclusive motion planning and control and builds upon two novel components—a global collision-inclusive planner and a local trajectory generator. Novel contributions relate to the low-level planner (Sec. IV and V) and the high-level planner (Sec. VI) in partially-known environments. The robot may collide with obstacles that were not detected at the time instance of generating the map. Instead of sensing the collision and stopping, the robot will continue and explore the unknown space for a period of time.

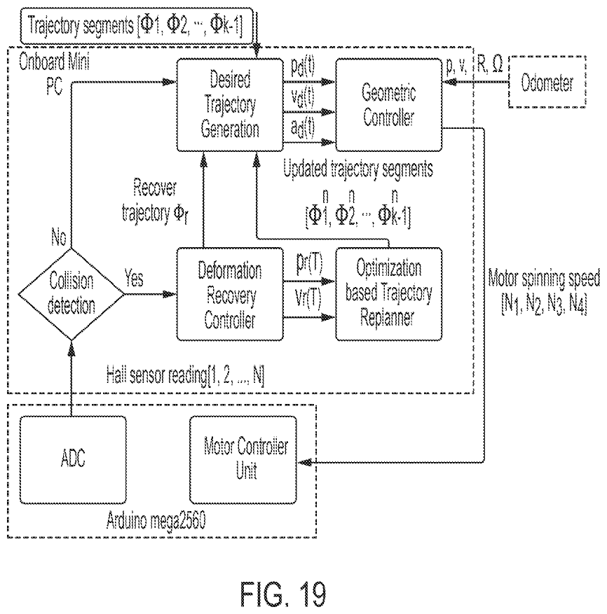

In contrast to collision avoidance algorithms, we do not impose any obstacle-related constraints in trajectory generation, nor we run a geometric collision check once a trajectory is generated at the low level. Instead, we directly generate a trajectory based on given waypoints (The list of waypoints can be computed via any path planning method. It is independent from our proposed collision-inclusive planning algorithm). If a collision occurs, the robot receives a signal that a collision has occurred from any of the Hall effect sensors embedded between the main chassis and its deflection surfaces and activates a deformation recovery controller. The controller (Sec. IV) makes the robot detach from the collision surface by recovering from the deformation, and determines a post-collision state for the robot so as to facilitate post-impact trajectory replanning. The replanner (Sec. V) refines the initial trajectory since collisions change the second-order continuity of the trajectory followed before collision. To do so, the replanner uses the post-collision state determined by the recovery controller as the initial state for refined trajectory generation. The procedure repeats as new collisions may occur in the future, in a reactive and online manner. The DRR strategy (along with specific implementation components for experimental evaluation) is visualized in FIG. 19. FIG. 19 shows a DRR strategy for a low-level planner.

Key notation is shown in Table. I.

| | |
|---|---|
| l₀ | neutral length of the spring |
| lₛ | pre-tensioned spring length (arm not compressed) |
| l^{e} | length at maximum spring load following Hooke's law. |
| l | current spring length (deformation vector) |
| p | position vector of the robot |
| v | velocity vector of the robot |
| a | acceleration vector of the robot |
| x⁻ | state vector prior to the collision and recovery |
| x⁺ | state vector post to the collision and recovery |
| kₑ | spring constant of the arm |
| k_{d} | damping coefficient of the arm. |
| _{b}^{w}R | Rotation matrix from body frame to world frame |
| _{c}^{w}R | Rotation matrix from collision frame F_{c} to world frame |

### IV. Deformation Recovery Control

The purpose of the deformation controller is to make the robot recover from a collision and reach a post-impact state that can facilitate recovery trajectory replanning (which is discussed in the next section).

### Problem Setting

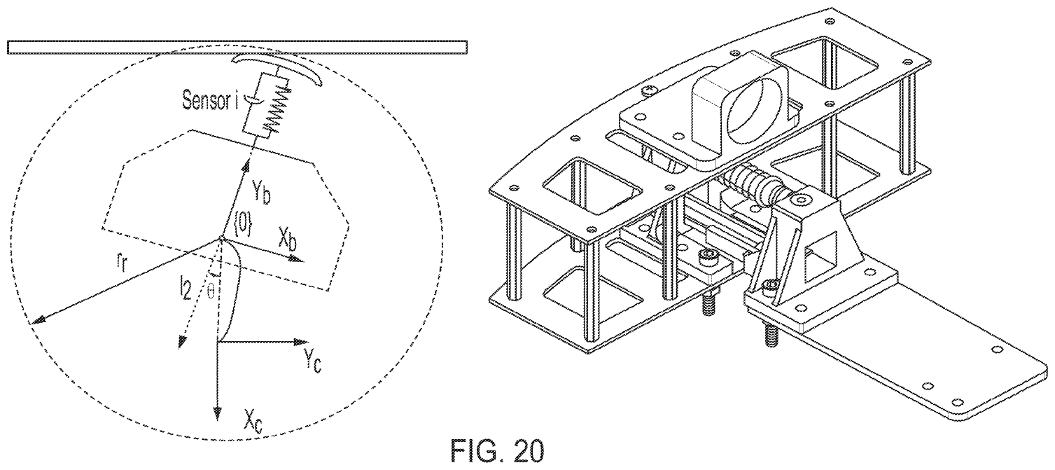

Consider a holonomic mobile robot, modeled as a point mass m. The robot's main chassis is connected to its deflection surfaces via visco-elastic prismatic joints (FIG. 20 shows a model of a wheeled robot equipped with compliant arms and a close-up view of the assembly of a visco-elastic prismatic joint and Hall effect sensor). Note that the springs inside each joint are pre-tensioned. The robot's compliant arms can both protect the robot from collision damage, and generate an external force driving it away from obstacles. External forces along each arm are caused via visco-elastic deformations assumed to follow the Voigt model; Ice and Ica denote the spring constant and damping coefficient, respectively. Hall effect sensors are used to measure the amount of deformation along each arm, and to signal collision detection when a user-tuned arm compression threshold is exceeded (The threshold is tuned based on the sensitivity of the Hall effect sensors). We consider four key quantities related to spring lengths: neutral I₀, pre-tensioned l₁, maximum-load lₑ, and current l (also referred to as deformation vector). These quantities play a significant role in the deformation recovery controller; they are also summarized in Table I, along with other key notation. In single-arm collisions, current spring length vector l is aligned with the unit vector along the colliding arm, pointing from the tip of the arm to the center of robot. For clarity of presentation, we consider in the following single-arm collisions. In the case of multi-arm collisions, we compute individual contributions from each colliding arm's spring and then consider their vector sum as the compound deformation vector which is used in lieu of l.

We use three coordinate systems. The world and body frames (note [symbol] denotes the rotation matrix from body frame to world frame while ^{b}l denotes the deformation vector expressed in the body frame), and a (local) collision frame F_{c}. This frame is defined at the time instant a collision occurs, t_{c}, remains fixed for the duration of the collision recovery process, T, and then it is deleted. Its origin coincides with the origin of the robot when a collision is detected. Basis vector {n, t, k} of F_{c} are defined normal, tangent and upwards with respect to the deformation vector l. Let θ be the angle of deformation vector l in F_{c}. The (frame-agnostic) robot collision dynamics is then given by

m\ddot{l}+k_{d}\dot{l}+kₑ(l−l₀)=maᵢₙ,

where aᵢₙ is the robot's body acceleration input as provided by the robot's motors.

### B. Deformation Controller

The deformation recovery controller's task is to steer the post-impact state of the robot to a desired one within a time period of [t_{c}; t_{c}+Tᵣ]. The time horizon Tᵣ is an important hyper-parameter tuned by the user. Typically, longer Tᵣ means the robot will recover from collision with longer time and smoother motion pattern; we select Tᵣ=0.5 s.

The deformation controller operates with respect to the local, collision frame F_{c}. Let the state variable be ^{c}s=[x y θ vₓ v_{y})]^{T}. The control input is u=[uₓ u_{y} u_{θ}]^{T}, where

$${u}_{x} = ( {}^{c} {a}_{i n} - \frac{{k}_{e}}{m} ( {}^{c} {l}_{s} - {}^{c} {l}_{0} ) ) \cdot {}^{c} n ,$$

$${u}_{y} = ( {}^{c} {a}_{i n} - \frac{{k}_{e}}{m} ( {}^{c} {l}_{s} - {}^{c} {l}_{0} ) ) \cdot {}^{c} t ,$$

$$and {u}_{θ} = {}^{c} ω \cdot {}^{c} k$$

with ^{c}ω being the angular velocity of the robot in the collision frame. Note that position control terms include compensation for the force caused by the spring being pre-tensioned when the robot's arm is at its rest length. Then, the state space model of the robot recovering from collision can be expressed as

$$\{ \begin{matrix}\begin{matrix}\begin{matrix}\begin{matrix}\dot{x} = {υ}_{x} \\ \dot{y} = {υ}_{y}\end{matrix} \\ \dot{θ} = {u}_{θ}\end{matrix} \\ {\dot{υ}}_{x} = - \frac{{k}_{e}}{m} x - \frac{{k}_{d}}{m} {υ}_{x} + {u}_{x}\end{matrix} \\ {\dot{υ}}_{y} = - \frac{{k}_{e} ( μ sign ( {υ}_{y} ) + tan θ ) x + {f}_{0}}{m} - \frac{{k}_{d} ( μ sign ( {υ}_{y} ) + tan θ ) {υ}_{x}}{m} + {u}_{y}\end{matrix} \qquad ( 1 )$$

where f₀=μkₑsign(v_{y})(^{c}lₛ−^{c}l₀)·^{c}n.

Since the robot is holonomic, we can decouple orientation from position control. In our approach we seek to make the robot keep the same orientation it has at the instant it collides throughout the collision recovery process. We follow this approach because it can simplify the overall deformation recovery control problem without sacrificing optimality. The orientation and angular velocity errors during recovery time t∈[t_{c}; t_{c}+Tᵣ] are e_{R} (t)=½(R_{d}^{T}−R^{T}R_{d})^{∨} and e_{\dot{R}}(t)=ω−R^{T}R_{d}ω_{d}, respectively. The vee map v is the inverse of a skew-symmetric mapping. Indexd denotes desired quantities; these are R_{d}=R(t_{c}) and ω_{d}=[0 0 0]^{T}. (All terms are with respect to collision frame F_{c}.) Then,

u_{θ}=Kᵣe_{R,z}(t)−K_{ω}e_{\dot{R},z}(t). (2)

Note that since this is a planar collision problem, the collision recovery orientation controller considers only the z-components of orientation and angular velocity errors.

Regarding collision recovery position control, note that the translation-only motion in (1) is affine. Thus, we can apply feedback linearization. The linearized system matrix F is

$$F = [ \begin{matrix}0 & 0 & 1 & 0 \\ 0 & 0 & 0 & 1 \\ - \frac{{k}_{e}}{m} & 0 & - \frac{{k}_{d}}{m} & 0 \\ 0 & 0 & 0 & 0\end{matrix} ]$$

with state vector x=[x y θ vₓ v_{y}]^{T}. The control input matrix is G=I_{2×2} with control input vector v=[vₓ v_{y}] given by

$$\{ \begin{matrix}{ν}_{x} = {u}_{x} \\ {ν}_{y} = {u}_{y} - \frac{{k}_{e} ( μ sign ( {υ}_{y} ) + tan θ ) x + {f}_{0}}{m} - \frac{{k}_{d} ( μ sign ( {υ}_{y} ) + tan θ ) {υ}_{x}}{m}\end{matrix} \qquad ( 3 )$$

We formulate an optimal control problem with fixed time horizon T based on the linearized system \dot{x}=Fx+Gv. Using the change of variable τ=t−t_{c}, we employ this change of variable for clarity. Problem (4) resets every time a new collision occurs; this gives rise to an LTI system, hence the change of variable can apply. We seek to solve

$${min}_{x} {{\int }_{0}}^{{T}_{r}} ( {x ( τ )}^{⊤} Γ x ( τ ) + {ν}^{⊤} ( τ ) H ν ( τ ) ) d τ \qquad ( 4 a )$$

$$subject to \dot{x} = Fx + G ν , \qquad ( 4 b )$$

$$- ‖ {l}_{e} - {l}_{s} ‖ cos θ \leq x \leq 0. \qquad ( 4 c )$$

$$x ( 0 ) = [ \begin{matrix}\begin{matrix}\begin{matrix}{x}_{0} & 0\end{matrix} & {υ}_{0 , x}\end{matrix} & {υ}_{0 , y} ] .\end{matrix} \qquad ( 4 d )$$

$$x ( {T}_{r} ) = [ \begin{matrix}\begin{matrix}\begin{matrix}0 & {y}_{{T}_{r}}\end{matrix} & {υ}_{{T}_{r} , x}\end{matrix} & {υ}_{{T}_{r} , y} ] .\end{matrix} \qquad ( 4 e )$$

Matrices

$$Γ = γ [ \begin{matrix}{I}_{2 \times 2} & 0 \\ 0 & {0}_{2 \times 2}\end{matrix} ]$$

and H=h I_{2×2} penalize the displacement during the recovery process and the control input, respectively. There is a trade-off between the displacement and the control input of the robot. Tuning parameters γ and h balance this trade-off to select the controller with minimal control energy and displacement.

Constraint (4c) dictates that the robot should be in contact with the collision surface until the colliding arm's spring has recovered its original, pre-tensioned length lₛ (i.e. the arm is no longer compressed) without compressing beyond its linear region lₑ. Constraints (4d) and (4e) enforce initial and terminal position and velocity conditions, respectively. In detail, x₀ is determined by the colliding arm's Hall effector sensor reading. Since the vector form of the sensor's reading (that is, ^{b}l−^{b}lₛ) is expressed in the body frame, we need transform it to the collision frame Fc as per

$${x}_{0} = - [ \begin{matrix}1 & 0\end{matrix} ] {}_{c}^{w} {R}^{⊤} {}_{b}^{w} R ( {}^{b} l - {}^{b} {l}_{s} ) . \qquad ( 5 )$$

The velocity components at the collision instant v_{0,x} and v_{0,y} are expressed in frame F_{c} and are estimated at runtime. In the experiments conducted in this work, velocity measurements are provided via a motion capture camera system, but the method applies as long as velocity estimates are available, e.g., via optical flow. Post-impact, the arm needs to be uncompressed (hence XT is set to 0), but y_{T} is treated as an unconstrained free variable. Post-impact terminal velocity components v_{T,x} and v_{T,y} are also expressed in F_{c} and can be set freely. Below, we discuss how to generate v_{T,x} and v_{T,y} based on the preplanned trajectory. We discretize the linearized system in (4b) with sampling frequency f=10 Hz using the Euler method, and solve the corresponding quadratic program with CVXOPT. The process is summarized in Alg. 1.

Computed control inputs (4) and (2) make the robot detach from the collision surface and help bring it to a temporary post-collision state which can be used as the initial condition for post-impact trajectory generation.

Algorithm 1: Deformation recovery controller

| | |
|---|---|
| input: | Displacement in body frame ^{b}ι − ^{b}ιₛ. |
| | via Hall effect sensors readings; collision |
| | time instant τ_{c} ∈ [0, Δtᵢ_{_{c}}); position in |
| | world frame at collision instant, ^{w}p_{τ}_{_{c}}; |
| | velocity in world frame at collision |
| | $instant , {( {}^{w} υ )}_{{τ}_{c}} ; rotation matrix {}_{b}^{w} R ;$ |
| | $rotation matrix {}_{c}^{w} R ; next waypoint$ |
| | point in world frame, ^{w}pₙₑₓₜ. |
| output: | Control input u |
| parameter: | Maximum velocity of the robot vₘₐₓ |

| 1 | Function REVOCERYCONTROLLER (^{b}ι − ^{b}ιₛ, τ_{c}, | | |
|---|---|---|---|
| | $Δ {t}_{{i}_{c}} , {( {}^{w} p )}_{{τ}_{c}} , {( {}^{w} p )}_{next} , {( {}^{w} υ )}_{{τ}_{c}} , {}_{b}^{w} R , {}_{c}^{w} R ) :$ | | |
| 2 | \| | ${}^{ω} {υ}_{T} ← \frac{{}^{ω} {p}_{next} - {}^{ω} {p}_{{τ}_{c}}}{Δ {t}_{{i}_{c}} - {τ}_{c}}$ | |
| 3 | \| | ${}^{c} {υ}_{T} ← {}_{c}^{ω} {R}^{⊤} {}^{ω} {υ}_{T}$ | |
| 4 | \| | if ^{c}v_{T,x} < 0 then | |
| 5 | \| | \| | ^{c}v_{T,x} ← 0 |
| 6 | \| | end | |
| 7 | \| | if ∥^{c}v_{T}∥ ≥ vₘₐₓ then | |
| 8 | \| | \| | ^{c}v_{T,y} ← vₘₐₓnormalize(^{c}v_{T}) |

| | | |
|---|---|---|
| 9 | \| | end |
| 10 | \| | Calculate x₀ based on (5) with ι_{b} |
| 11 | \| | v_{T,x} ← ^{c}v_{T,x}, v_{T,y} ← ^{c}v_{T,y} |
| 12 | \| | Calculate uₓ, u_{y} based on (4) and (3) with given |
| | \| | v_{T,x}, v_{T,y} and x₀ |
| 13 | \| | Calculate u_{θ} based on (2) |
| 14 | \| | u ← [uₓ u_{y} u_{θ}]^{T} |

| | |
|---|---|
| 15 | return u |

### V. Post-Impact Trajectory Replanning

### A. Problem Formulation

We formulate the post-impact trajectory generation problem as a quadratic program with equality constraints. Let

$${J}_{s}^{′} = {\sum }_{β ∈ \{ x , y \}} {\sum }_{i = {i}_{c}}^{{N}_{I}} {}^{w} {η}_{i , β}^{T} {( {}^{w} Q )}_{β}^{q} ( Δ {t}_{i} ) {}^{w} {η}_{i , β} ,$$

where i_{c} is the segment where the collision happens and N_{I} is the number of trajectory segments. We seek to solve

$${min}_{η} {J}_{s} ( η ) = {\sum }_{i = {i}_{c}}^{{N}_{I}} {{\int }_{0}}^{Δ {t}_{i}} ‖ {}^{w} {p}_{i}^{( q )} ( t ) ‖ dt = {J}_{s}^{′} \qquad ( 6 a )$$

$$subject to {}_{}^{w} {A}_{0 , {i}_{c} , β}^{( 0 )} {η}_{{i}_{c} , β} = {}^{w} {p}_{r , β}^{} , \qquad ( 6 b )$$

$${}_{}^{w} {A}_{0 , {i}_{c} , β}^{( 1 )} {η}_{{i}_{c} , β} = {}_{}^{w} {v}_{r , β}^{} , \qquad ( 6 c )$$

$${}_{}^{w} {A}_{Δ {t}_{I} , I , β}^{( α )} {η}_{I , β} = {}_{}^{w} {d}_{Δ {t}_{I} , I , β}^{( α )} , \qquad ( 6 d )$$

$${}_{}^{w} {A}_{Δ {t}_{i} , i , β}^{0} {η}_{i , β} = {}_{}^{w} {p}_{i + 1 , β} , \qquad ( 6 e )$$

$${}_{}^{w} {A}_{Δ {t}_{i} , i + 1}^{( α )} {η}_{i , β} = {A}_{0 , i + 1 , β}^{( α )} {η}_{i + 1 , β} . \qquad ( 6 f )$$

Superscript q denotes the derivative order; for example, q={1, 2, 3, 4} correspond to min-velocity, min-acceleration, min-jerk and min-snap trajectories, respectively. Subscript β∈{x,y} indicates the x and y component of the trajectory, and Δtᵢ is the time duration for i^{th} polynomial segment. Parameter η_{i,β} is the vector of coefficients of i^{th} polynomial. ^{w}A_{0,i,β}^{(α)} maps the coefficients to α^{th} order derivative of the start point in segment i, while ^{w}A_{Δt}_{ᵢ}_{,i,β}^{(α)} maps the coefficients to α^{th} order derivative of the end point in segment i, for α∈{0, 1, . . . j−1}.

Constraints (6b) and (6c) impose the initial values for the 0^{th} and the 1^{st} order derivatives to match the position and velocity values attained via the collision recovery controller, respectively. Constraint (6d) imposes that the α^{th} order derivatives of the end position are fixed. Constraint (6e) imposes that the trajectory will pass through desired waypoints after Constraint (6f) is imposed to ensure α^{th} continuity among polynomial segments.

We solve this quadratic programming (QP) problem given initial (post-collision) and end states, and intermediate waypoints. Then, we perform time scaling to reduce the maximum values for planned velocities, accelerations and higher-order derivatives as appropriate, and thus improve dynamic feasibility of the refined post-impact trajectory.

The solution of the QP problem serves as the initial value for GTO where we change the objective function to

min λₛJₛ+λₒJₒ+λ_{d}(Jᵥ+Jₐ), (7)

where Jₒ is the cost to avoid collisions, and Jᵥ and Jₐ are the penalties when candidate velocity and acceleration solutions exceed the dynamic feasibility limit, respectively. Weight parameters λₛ, λₒ and λ_{d} trade off between smoothness, trajectory clearance and dynamical feasibility, respectively.

We use an exponential cost function. At a position with distance d to the closest obstacle, the cost cₒ(d) is written as

cₒ(d)=αₒ exp(−d−dₒ)/rₒ, (8)

where αₒ is the magnitude of the cost function, dₒ is the threshold where the cost starts to rapidly rise, and rₒ controls the rate of the function's rise. Then, Jₒ can be computed as

$$\begin{matrix}{J}_{o} = {\sum }_{i = {i}_{c}}^{{N}_{I}} {{\int }_{0}}^{Δ {t}_{i}} {c}_{o} ( p ( t ) ) ‖ v ( t ) ‖ dt \\ = {\sum }_{i = {i}_{c}}^{{N}_{I}} {\sum }_{k = 0}^{N} {c}_{o} ( p ( {t}_{k} ) ) ‖ v ( {t}_{k} ) ‖ δ t\end{matrix} . \qquad ( 9 )$$

Jᵥ can be computed in a similar manner, whereby cᵥ(v) is the cost function applied on the velocity and attains the same form as in (8). We can then obtain

$$\begin{matrix}{J}_{v} = {\sum }_{β ∈ \{ x , y \}} {\sum }_{i = {i}_{c}}^{{N}_{I}} {{\int }_{0}}^{Δ {t}_{i}} {c}_{v} ( {v}_{β} ( t ) ) ‖ {a}_{β} ( t ) ‖ dt \\ = {\sum }_{β ∈ \{ x , y \}} {\sum }_{i = {i}_{c}}^{{N}_{I}} {\sum }_{k = 0}^{N} {c}_{v} ( {v}_{β} ( {t}_{k} ) ) ‖ {a}_{β} ( {t}_{k} ) ‖ δ t\end{matrix} . \qquad ( 10 )$$

The formulation of Jₐ is similar to (10). The cost function of the acceleration constraint cₐ(a) is also an exponential function similar to c_{d}(d) and cᵥ(v), since it is can penalize when close to or beyond acceleration bounds while staying flat when away from the bounds. We apply a Newton trust region method to optimize the objective.

### B. Waypoint Adjustment

In some cases, it may be necessary to adjust the waypoints given by a preplanned trajectory with the information obtained from the collision, and then solve the aforementioned problem in Sec. V-A with the adjusted waypoints. Such cases occur when there is no direct line of sight between the collision state and the waypoint at the end of the immediately next trajectory segment following collision recovery. By enabling such waypoint adjustment, the algorithm promotes exploration and in certain cases prevents the robot from being trapped in a local minima in which repeated collisions at the same (or very close-by) place could otherwise occur.

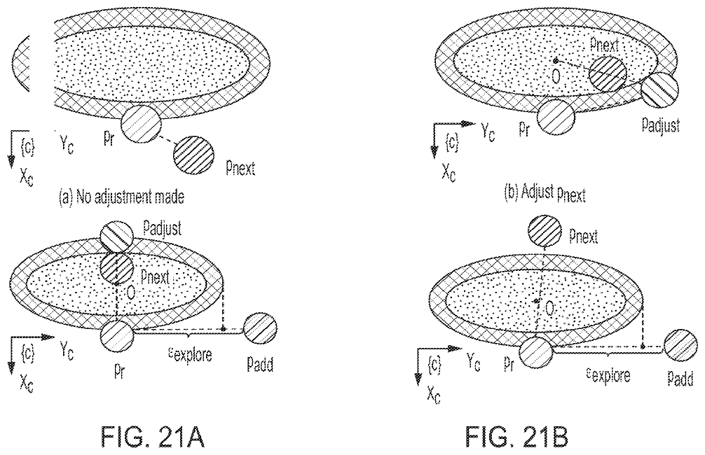

With reference to Alg. 2, we express in the local collision frame F_{c} the next waypoint ^{w}waypoint_list[i_{c}+1] (lines 2-4). In line 5, we adjust ^{w}waypoint_list with the information we get from collision. Details of this process are shown in FIG. 21. FIG. 21A and FIG. 21B show waypoint adjustment process when a collision is sensed.

If the waypoint at the end of i_{c} segment lies on the opposite direction of ^{c}pᵣ, we insert a new intermediate waypoint in the waypoint list. The waypoint is generated by displacing ^{c}pᵣ by an ‘exploration distance’ ∈ₑₓₚₗₒᵣₑ expressed in F_{c} as FIG. 21. When the robot collides with an obstacle in unknown space, we use a fixed (user-defined) exploration distance. If the robot collides with the obstacle in unknown space again, we make the robot stop to recover from the deformation caused by collision. If a new waypoint is inserted in the list, we map the path generated by ^{w}pᵣ and waypoints in the list after i_{c}+1 into time domain using a trapezoidal velocity profile. If no new waypoint is inserted, we set the time duration of i_{c} segment in (6) as Δt_{c}=t_{ic+1}−t_{c}, where t_{ic+1} is the time reaching the next waypoint pᵢ+1 per the preplanned trajectory.

Algorithm 2: Post-impact waypoint adjustment

| | |
|---|---|
| input: | Position after the collision recovery in |
| | world frame, ^{w}pᵣ; waypoint list of |
| | preplanned trajectory; |
| | ${}^{w} waypoint\_list ; {}_{c}^{ω} R ; trajectory$ |
| | segment i_{c} where the collision happens. |
| output: | waypoint list after adjustment |
| | ^{w}waypoint_list |
| parameter: | Robot radius τ_{rob} |

| 1 | Function WAYPOINTADJUSTMENTLINE (^{w}pᵣ, | |
|---|---|---|
| | ${}^{w} waypoint\_list , {}_{c}^{ω} R , {i}_{c} ) :$ | |
| 2 | \| | ^{w}pₙₑₓₜ ← ^{w}waypoint_list[i_{c} + 1] |
| 3 | \| | Transfer ^{w}pₙₑₓₜ into [symbol] _{c} frame to get ^{c}pₙₑₓₜ |
| 4 | \| | Transfer ^{w}pᵣ into [symbol] _{c} frame to get ^{c}pᵣ |
| 5 | \| | Adjust ^{c}pₙₑₓₜ and insert a waypoint in the |
| | \| | ^{w}waypoint_list as FIG. 21 |

| | |
|---|---|
| 6 | return ^{c}waypoint_list |

### VI. Search-Based Collision-Inclusive Planning

In this section, we propose the main algorithm to generate the waypoint list and trajectory segments that serve as the input to the DRR strategy.

FIG. 21: Waypoint adjustment process when the collision is sensed.

### A. Problem Formulation

Let x(t)∈ [symbol] ⊂ [symbol] ^{n×q} be a dynamical system state, consisting of position and its (q−1) derivatives (velocity, acceleration, jerk, etc.) in 2D (n=2) or 3D (n=3). Let X_{free}⊂X denote the free region of the state space that, in addition to capturing the obstacle-free positions P_{free}, also specifies constraints D_{free} on system dynamics, i.e. minimum and maximum velocity vₘᵢₙ, vₘₐₓ, acceleration aₘᵢₙ, aₘₐₓ, jerk jₘᵢₙ, jₘₐₓ and higher order derivatives in each axis. Note that P_{free} is bounded by the size of the environment. Thus, X_{free}=P_{free}×D_{free}=P_{free}×[vₘᵢₙ, vₘₐₓ]×[aₘᵢₙ, aₘₐₓ]× . . . . We denote the obstacle region as P^{obs}=P\P_{free} and X^{obs}=P^{obs}×D^{free}.

The differential flatness of mobile robot systems allows us to construct control inputs from 1D time-parameterized polynomial trajectories specified independently in each of the n position axes (n=2 or n=3). Thus, we consider polynomial state trajectories

x(t)=[p_{D}(t)^{T},\dot{p}_{D}(t)^{T}, . . . ,p_{D}^{(q-1)}(t)^{T}]^{T}

where

$${p}_{D} ( t ) = {\sum }_{i = 0}^{q} {d}_{i} \frac{{t}^{i}}{i !}$$

and D=[d₀, . . . , d_{q}]⊂ [symbol] ^{n×(q+1)}, and dᵢ=[d_{i,x}d_{i,y}]^{T} in (6). To simplify the notation, we denote the system's velocity by v(t)=\dot{p}_{D}^{T}(t), acceleration by a(t)=\ddot{p}_{D}^{T}(t), jerk by j(t)= [symbol] _{D}^{T}(t), etc., and drop the subscript D where convenient.

Polynomial trajectories can be generated via a linear time-invariant dynamical system p_{D}^{(q)}(t)=u(t), where the control input is u(t)∈ [symbol] =[−uₘₐₓ,uₘₐₓ]ⁿ⊂ [symbol] ⁿ. In state space form we obtain \dot{x}(t)=A_{f}x(t)+B_{f}u(t), with

$${A}_{f} = [ \begin{matrix}0 & {I}_{n} & 0 & … & 0 \\ 0 & 0 & {I}_{n} & … & 0 \\ 0 & … & … & 0 & {I}_{n} \\ ⋮ & ⋱ & ⋱ & ⋱ & ⋮ \\ 0 & … & … & 0 & 0\end{matrix} ] , {B}_{f} = [ \begin{matrix}0 \\ 0 \\ ⋮ \\ 0 \\ {I}_{n}\end{matrix} ] . \qquad ( 11 )$$

In collision-inclusive motion planning, we consider a smoothness cost

$${J}_{s} ( D ) = {\sum }_{k = 1}^{K} {{\int }_{0}}^{{T}_{k}} {‖ u ( t ) ‖}^{2} dt = {\sum }_{k = 1}^{K} {{\int }_{0}}^{{T}_{k}} {‖ {p}_{k , D}^{( q )} ( t ) ‖}^{2} dt .$$

The trajectory is not qth order differentiable as it would be in a collision-avoidance problem formulation. The smoothness of the entire trajectory is the summation of the qth order differentiable segments of the entire trajectory. We consider two additional costs. First,

$${T}_{g} = {\sum }_{k = 1}^{K} {T}_{k}$$

penalizes duration of the overall trajectory. Then,

$${J}_{c} = \frac{{( {\vert}^{c} {v}_{x}^{+} \vert - {\vert}^{c} {v}_{x}^{-} \vert )}^{2} + {\sum }_{β ∈ \{ y , z \}} Δ {E}_{β}}{{T}_{r}} \qquad ( 12 )$$

evaluates the effect of a collision in changing the direction of motion of the robot. ΔE_{β}=(^{c}v_{β}⁺−^{c}v_{β}⁻)², where ^{c}v_{β}⁺=^{c}v_{β}(t+Tᵣ) and ^{c}v_{β}⁻=^{c}v_{β}(t). ^{c}v_{β}⁺ can be approximated via Alg. 4 if p_{goal} is known. (We discuss Alg. 4 in detail in Sec. VI-D.) We also define an indicator function ζ(t)={0,1} that signals if the robot is colliding at time instant t.

We can then define the optimization problem

$${min}_{D , {T}_{g}} {J}_{s} ( D ) + {ρ}_{t} {T}_{g} + {ρ}_{c} {J}_{c} ( ζ ( t ) ) \qquad ( 13 a )$$

$$subject to \dot{x} ( t ) = {A}_{f} x ( t ) + {B}_{f} u ( t ) , ∀ ζ ( t ) = 0 , \\ ∀ t ∈ [ 0 , {T}_{g} ] \qquad ( 13 b )$$

$$x ( t + {τ}_{r} ) = {F}_{DRR} ( x , ( t ) ) , ∀ ζ ( t ) = 1 , \\ ∀ t ∈ [ 0 , {T}_{g} - {T}_{r} ] , ∀ {τ}_{r} ∈ [ 0 , {T}_{r} ] \qquad ( 13 c )$$

$$ζ ( t ) ∈ \{ 0 , 1 \} , ∀ t ∈ [ 0 , {T}_{g} ] \qquad ( 13 d )$$

$$ζ ( t ) = 0 , if x ( t + δ t ) ∈ {χ}^{free} , δ t \to 0 , \\ ∀ t ∈ [ 0 , {T}_{g} ] \qquad ( 13 e )$$

$$ζ ( t ) = 1 , if x ( t + δ t ) ∈ {χ}^{obs} , δ t \to 0 , \\ ∀ t ∈ [ 0 , {T}_{g} - {T}_{r} ] \qquad ( 13 f )$$

$$x ( 0 ) = {x}_{0} , x ( {T}_{g} ) ∈ {χ}^{goal} , \\ ζ ( 0 ) = 0 , ζ ( {T}_{g} ) = 0 \qquad ( 13 g )$$

$$x ( t ) ∈ {χ}^{free} , u ( t ) ∈ 𝒰 , ∀ t ∈ [ 0 , {T}_{g} ] \qquad ( 13 h )$$

$${c}^{} {v}_{x} ( t ) ∈ {𝒱}^{c} , if ζ ( t ) = 1. \qquad ( 13 i )$$

Parameters ρᵢ>0 and ρ_{c}>0 regulate the relative importance of trajectory smoothness, duration, and amount of collisions that switch the direction of motion. Conditions (13e) and (13f) determine how the value for ζ(t) is being set. In (13i), v^{c}=[−v_{max,c}, v_{max,c}]; v_{max,c} indicates the maximum collision velocity which, if exceeded, will lead to the robot flipping over. Thus, we set the pre-collision velocity component along x axis of F_{c} as vₓ (t)∈V^{c}.

In this paper, we show that, similar to the collision avoidance motion planning problem, these safety constraints can be handled by converting the problem to a deterministic shortest path problem with a n×q dimensional state space X and a n dimensional control space u. Since the control space u is always n dimensional, a search based planning algorithm such as A* that discretizes u using motion primitives is efficient and resolution-complete, i.e. it can compute the optimal trajectory in the discretized space in finite-time, unlike sampling-based planners.

### B. Motion Primitives

First, we construct motion primitives for the system (11) that will allow us to convert the motion planning problem from an optimal control problem to a graph-search problem. Instead of using the control set u, we consider a lattice discretization u_{M}={u₁, . . . , u_{M}}, where each control u_{M}∈ [symbol] ⁿ vector defines a motion of short duration for the system. One way to obtain the discretization u_{M} is to choose a number of samples μ∈ [symbol] ⁺ along each axis [−v_{max,c}, v_{max,c}], which defines a discretization step:

$$du = \frac{{u}_{max}}{r}$$

and result in M=(2r+1)ⁿ motion primitives. Given an initial state x₀=[p₀^{T}, v₀^{T}, . . . ]^{T}, we generate a motion primitive of duration τ>0 that applies a piece-wise constant control

$${\tilde{u}}_{m} ( t ) = \{ \begin{matrix}{u}_{m} & {p}_{D}^{( q - 1 )} ( t ) ∈ [ {p}_{D , min}^{( q - 1 )} , {p}_{D , max}^{( q - 1 )} ] , \\ 0 & {p}_{D}^{( q - 1 )} ( t ) ∉ [ {p}_{D , min}^{( q - 1 )} , {p}_{D , max}^{( q - 1 )} ]\end{matrix} \qquad ( 14 )$$

where uₘ∈ [symbol] _{M} for t∈[0, τ]. With an initial condition x₀,

$${p}_{D} ( t ) = {\tilde{u}}_{m} ( t ) \frac{{t}^{q}}{q !} + … + {v}_{0} t + {p}_{0} \qquad ( 15 )$$

is a piece-wise function. Equivalently, the resulting trajectory of the linear time invariant system (11) is

$$x ( t ) = \underbrace{{e}^{{A}_{f} t}}_{{A}_{df} ( t )} {x}_{0} + \underbrace{{\int }_{0}^{t} {e}^{{A}_{f} ( t - σ )} {B}_{f} {\tilde{u}}_{m} ( σ ) d σ}_{{B}_{df} ( t ) {u}_{m}} . \qquad ( 16 )$$

This discretization of the state space allows us to construct a graph representation of the reachable system states by starting at x₀ and applying all primitives to obtain the M possible states after a duration of τ∈[0, τ_{f}]. (see Alg. 3). Applying all possible primitives to each of the M states again, will result in M² possible states at time 2τ. Since the free space X^{free} is bounded and discretized, the set of reachable states S is finite. This defines a graph [symbol] (S, ε), where S is the discrete set of reachable system states and ε is the set of edges that connect states in the graph, each defined by a motion primitive e=(ũₘ, τ, c) with c an integer value (discussed in Sec. VI-D).

We use Alg. 3 to explore the free state space X^{free} and build the connected graph: in line 4, the primitive is calculated using the fully defined state s and a control input uₘ given the constant time upper-bound τ_{f}; lines 6-29 check whether the primitive intersects with the obstacles and then modify those primitives intersecting with the obstacles. This step will be further discussed Sec. VI-D. Line 14 shows that we consider Tᵣ for the robot recovering from the collision using DRR in the cost function. In lines 7-17, we modify the end state of the primitive and add it to the set of successors of the current node; meanwhile, we estimate the edge cost related to from the corresponding modified primitive. Further modification of the cost function about estimating the cost related to J_{c} part will be discussed in Sec. VI-D. In lines 20-28, we evaluate the end state of a valid primitive not intersecting with the obstacles and we add it to the set of successors of the current node; meanwhile, we estimate the

Algorithm 3: Collision-inclusive motion primitive generation

| input | : | Initial state x ∈ [symbol] ⊂ [symbol] ^{free}: motion |
|---|---|---|
| | | primitive set [symbol] _{M}, upper-bound of |
| | | duration τ_{f} |
| output | : | Reachable set [symbol] (x) from x in one step; |
| | | costs set [symbol] (x): duration set [symbol] (x); |
| | | collision states set [symbol] (x) |
| parameter | : | Time interval δt; recover time [symbol] ᵣ in |

DRR

| 1 | Function GETMOTIONPRIMITIVE (s, [symbol] _{M}, τ_{f} ) : | | | |
|---|---|---|---|---|
| 2 | \| | [symbol] (x) ← ∅, [symbol] (x) ← ∅, [symbol] (x) ← ∅, [symbol] (x) ← ∅ | | |
| 3 | \| | for all uₘ ∈ [symbol] _{M} do | | |
| 4 | \| | \| | Calculate edge eₘ(t) according to (16) for | |
| | \| | \| | t ∈ [0, τ_{f} ] | |
| 5 | \| | \| | if e(t) ∈ [symbol] ^{free} for all t ∈ [0, τ_{f} ] then | |
| 6 | \| | \| | \| | ζₘ ← 0 |
| 7 | \| | \| | \| | τₘ ← τ_{f} |
| 8 | \| | \| | \| | xₘ ← eₘ (τ_{f} ) |
| 9 | \| | \| | \| | [symbol] (x) ← [symbol] (x) ∪{xₘ} |
| 10 | \| | \| | \| | J_{D} ← ∫₀^{τ} ∥ũₘ(t)∥²dt |
| 11 | \| | \| | \| | J_{c} ← 0 |
| 12 | \| | \| | \| | [symbol] (x) ← [symbol] (x) ∪{J_{D} + ρₜτ_{f} + J_{c}} |
| 13 | \| | \| | \| | [symbol] (x) ← [symbol] (x) ∪{τₘ} |
| 14 | \| | \| | \| | ζ(x) ← [symbol] (x) ∪{ζₘ} |
| 15 | \| | \| | else | |
| 16 | \| | \| | \| | ζₘ ← 1 |
| 17 | \| | \| | \| | Generate xₘ, τ and calculate J_{c} or prune |
| | \| | \| | \| | this primitive which will discussed in |
| | \| | \| | \| | VI-D and VI-F. |
| 18 | \| | \| | \| | [symbol] (x) ← [symbol] (x) ∪{xₘ} |
| 19 | \| | \| | \| | J_{D} ← ∫₀^{τ} ∥ũₘ(t)∥²dt |
| 20 | \| | \| | \| | [symbol] (x) ← [symbol] (x) ∪{J_{D} + ρₜ(τ + [symbol] ᵣ) + J_{c}} |
| 21 | \| | \| | \| | [symbol] (x) ← [symbol] (x) ∪{τₘ} |
| 22 | \| | \| | \| | ζ(x) ← [symbol] (x) ∪{ζₘ} |

| | | | |
|---|---|---|---|
| 23 | \| | \| | end |

| | | |
|---|---|---|
| 24 | \| | end |

| | |
|---|---|
| 25 | return [symbol] (x), [symbol] (x), [symbol] (x), [symbol] (x) |

edge cost from the corresponding primitive. After checking through all the primitives in the finite control input set, we add the nodes in successor set R(x) to the graph, and we continue expanding until we reach the goal region.

### C. Deterministic Shortest Trajectory

Given the set of motion primitives u_{M} and the induced space discretization discussed in the previous section, we can re-formulate problem (13) as a graph-search problem. This can be done by introducing additional constraints for the control input u(t) in (13) to be piecewise-constant. We introduce an additional variable N∈ [symbol] ⁺, so that

$${T}_{g} = {\sum }_{k = 0}^{N - 1} ( {τ}_{k} + {ζ}_{k + 1} {T}_{r} ) ,$$

and ũₖ is computed by (14) with uₖ∈u_{M} for k=0, . . . , N−1 and a constraint in (13h):

$$u ( t ) = {\sum }_{k = 0}^{N - 1} {\tilde{u}}_{k} {t ∈ [ {T}_{k} , {T}_{k + 1} ]}_{} .$$

We define

$${T}_{i} = {\sum }_{k = 0}^{i - 1} {τ}_{k} ,$$

to force the control trajectory to be a composition of the motion primitives in u_{M}, leading to the following deterministic shortest path problem. Given an initial state x₀∈X^{free} a goal region X^{goal} and a finite set of motion primitives UM with duration τ>0, choose a sequence of motion primitive u_{0:N-1} of length N such that:

$${min}_{N , {u}_{0} , N - 1} {\sum }_{k = 0}^{N - 1} {‖ {u}_{k} ‖}^{2} + {ρ}_{t} ( {τ}_{k} + {ζ}_{k + 1} {T}_{r} ) + {ρ}_{c} {J}_{c , k} \qquad ( 17 a )$$

$$subject to x ( \tilde{t} ) = {A}_{df} ( \tilde{t} ) {x}_{k} + {B}_{dk} ( \tilde{t} ) {u}_{k} ⊂ {χ}^{free} , \\ ∀ \tilde{t} ∈ [ 0 , {τ}_{k} ] \qquad ( 17 b )$$

$${ζ}_{k} ∈ \{ 0 , 1 \} , ∀ k ∈ \{ 0 , 1 , … N - 1 \} \qquad ( 17 c )$$

$${ζ}_{k + 1} = 0 , if x ( {τ}_{k} + δ t ) ∈ {χ}^{free} , δ t \to 0 \qquad ( 17 d )$$

$${ζ}_{k + 1} = 1 , if x ( {τ}_{k} + δ t ) ∈ {χ}^{obs} , δ t \to 0 \qquad ( 17 e )$$

$${x}_{k + 1} = x ( {τ}_{k} ) , ∀ {ζ}_{k + 1} = 0 \qquad ( 17 f )$$

$${x}_{k + 1} = {F}_{DRR} ( x ( {τ}_{k} ) ) , ∀ {ζ}_{k + 1} = 1 \qquad ( 17 g )$$

$${x}_{0} = {x}_{0} , {x}_{N} ∈ {χ}^{goal} , {ζ}_{0} = 0 , {ζ}_{N} = 0 \qquad ( 17 h )$$

$${u}_{k} ∈ {𝒰}_{M} \qquad ( 17 i )$$

$${}^{c} {v}_{k , x}^{-} ∈ {𝒱}^{c} , if {ζ}_{k} = 1. \qquad ( 17 j )$$

The optimal cost of (17) is an upper bound to the optimal cost of (13) because (17) is a constrained version of (13). However, this reformulation to discrete control and state-spaces enables an efficient solution. Such problems can be solved via search-based or sampling-based motion planning algorithms. Since only the former can guarantee finite time (sub-)optimality, we use an A* method similar to and focus on the design of efficient, guaranteed collision checking and post-collision behavior classifying methods, and an accurate, consistent heuristic as follows.

### D. Collision Checking and Post-collision Behaviors

For a computed edge e(t)=[p(t)^{T} v(t)^{T} a(t)^{T} . . . ]^{T}, in Alg. 3, we need to check if e(t)∈X^{free} for all t∈[0, τ_{f}]. For e(t)∈ [symbol] ^{free}∧e(t+δt)∈ [symbol] ^{obs} with δt→0 for all t∈[0, τ_{f}], we need to modify the edge e(t) as in lines 6-16 in Alg. 3. We check collisions in the geometric space [symbol] ^{free}⊂ [symbol] ⁿ separately from enforcing dynamic constraints [symbol] ^{free}⊂ [symbol] ^{n×(q-1)}. An edge e(t) is collision-free only if its geometric shape pₑ(t)∈P^{free} for all t∈[0, τ_{f}].

In general, determining collision points for each motion primitive can be very challenging. In this work, we model P as an occupancy grid map Mₒ. Other representations such as polyhedral maps are also possible but are usually hard to obtain from a robot's FoV sensor data (from LIDAR) and hence not pursued herein. Let Pₑ={pₑ(tᵢ)|tᵢ∈[0,τ_{f}], i=1, . . . I} be a set of positions that the system traverses along the trajectory. For collision-free primitives we need pₑ(tᵢ)∈P^{free} for all i∈{0, . . . I}. The duration of the collision-free trajectory is τ=τ_{f}.

For the given polynomial pₑ(t), t∈[0, τ_{f}], the positions pₑ(tᵢ) are sampled by defining

$${t}_{i} = \frac{i}{I} {τ}_{f}$$

such that

$$\frac{τ}{I} {v}_{max} \geq {ϵ}_{map} , \qquad ( 18 )$$

where ∈ₘₐₚ is the occupancy grid resolution, and parameter vmax is calculated as vₘₐₓ=max{|vₘᵢₙ|, |vₘₐₓ|}. The condition ensures that the maximum distance between two consecutive samples will not exceed the map resolution. Since it is an approximation, some cells that are traversed by pₑ(t) with a portion of the curve within the cell shorter than ∈ₘₐₚ may be missed, but it guarantees the collision-free trajectory not hitting any obstacles.

In not collision-free e(t), the estimated collision time instance tᵢ is when pₑ(tᵢ)∈ [symbol] ^{free}∧pₑ(tᵢ+δt)∈ [symbol] ^{obs} with δt≈tᵢ₊₁−tᵢ for all i∈{0, . . . I−1}. In this case, we set the duration τ of the collision-inclusive motion primitives in Alg. 3 as tᵢ. Then, we modify the end state xₑ of this e(t) as xₑ={ₑ⁻, xₑ⁺} with xₑ⁻=e(tᵢ)=[pₑ(tᵢ)^{T} vₑ(tᵢ)^{T} aₑ(tᵢ)^{T} . . . ]^{T}. We set the duration of this edge τ=tᵢ and set ζ(τ)=1. xₑ⁺=F_{DRR}(xₑ⁻) is the post-impact state recovered using the DRR strategy. We discuss how to set xₑ⁺ shortly.

Since v, a and other higher-order derivatives are polynomial functions, we can compute their extrema within the time period [0, τ] to check if the respective maximum bounds are violated. For n≤3, the order of these polynomials is less than 5, which means we can solve for the extrema in closed form. We prune those primitives which are not dynamically feasible (i.e. any bounds are exceeded). For the collision-inclusive primitives, we need to check the x component of the velocity vₑ⁻ in F_{c} corresponding ^{c}v_{e,x}⁻∈ [symbol] . We prune those with ^{c}v_{e,x}⁻∉ [symbol] to prevent the robot from flipping over after colliding.

To generate the frame F_{c} required for evaluating the collision-inclusive primitives, we need to get the geometric information of each obstacle that the robot collides on. Therefore, we need to generate a grid map M_{inf} with the same resolution of the occupancy map to record the geometric information of the obstacles. With the information we get from a FoV-based sensor (e.g., LIDAR), we can create a list of obstacles in the field. Then, we create a grid map that can map the position grid ((xᵢ, yᵢ) for 2D map) to a list which stores the geometric features of the convex obstacles. In practice we use the open-source obstacle detector package to create two kinds of obstacle lists according to the sensor data: circle shape obstacles and line segment shape obstacles (which can be used to create convex polygon obstacles). The geometric information map M_{inf} will help us generate F_{c}. Basis vectors of F_{c} are generated as discussed in Sec. IV-A whereas the origin of F_{c} is set to be the estimated position of collision pₑ⁻ in xₑ⁻.

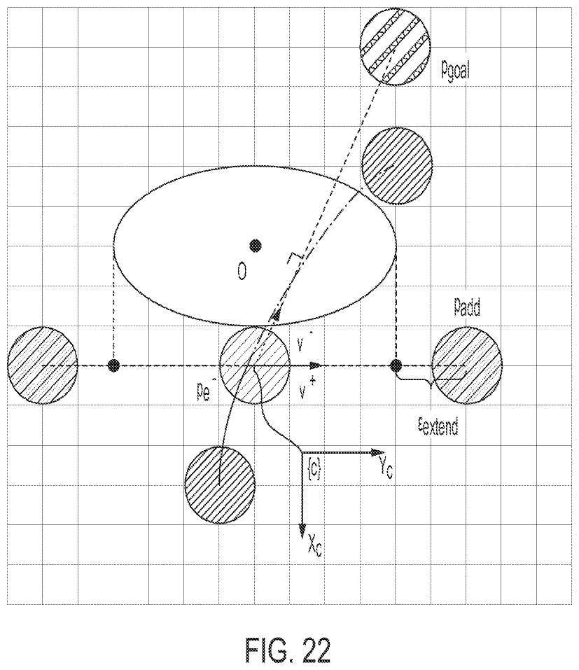

FIG. 22 shows an example of performing collision and detouring away from a convex obstacle by generating a new waypoint among the point of collision and the goal.

After generating F_{c}, we are able to generate xₑ⁺ based on the geometric information of the obstacle obs^{c} which we predict the robot will collide on when arriving at xₑ⁻ with the given motion primitive. Given the goal position p_{goal}, we are able to set ^{w}xₑ⁺ according to Alg. 4. This way, we can ensure the trajectory generated by the search based algorithm respect constraint (17g). In FIG. 22, we show how to generate the intermediate waypoint p_{add}. We first generate two possible candidates in FIG. 22. We select p_{add} between the two candidates as the one that creates the shortest feasible path (pₑ⁻→p_{add}→p_{goal}) to the goal. If there is no feasible path to the goal, we prune this collision-inclusive motion primitive. Given ^{c}vₑ⁻ and ^{c}vₑ⁺, we can generate J_{c} of this collision-inclusive motion primitive according to (12). We consider that most of the collision energy can be recovered by the robot via its compliant arms. In practice, precise computation of the dissipated energy is a challenge; however, the DRR strategy accommodates for collision energy losses without any explicit energy dissipation models.

We set a lower bound to J_{c}, J_{-c}, to ensure that there is a cost if the robot tries to use collisions alone to steer. Tuning ρ_{c} can help regulate between collision avoidance and collision-inclusive planned trajectories.

We also create an infeasible, P^{inf}, area to link pruned collision-inclusive pₑ⁻∈ [symbol] ^{inf} and collision-free primitives pₑ∈ [symbol] ^{inf}. We apply P^{inf} to prevent the robot from getting into areas where the collisions are difficult to detect using this arm design (i.e. when collision surfaces reduce to almost a point, such as obstacle corners).

### E. Heuristic Function Design

Devising an efficient graph search for solving (17) requires an approximation of the optimal cost function (a heuristic function) that is admissible, informative (i.e. provides a tight approximation of the optimal cost), and consistent (i.e. it can be inflated in order to obtain solutions with bounded suboptimality efficiently. We obtain a good heuristic function by solving a relaxed version of (13). The main idea is to replace constraints in (13) that are difficult to satisfy, namely, x(t)∈ [symbol] ^{free} and u(t)∈ [symbol] , with a constraint on the time T. In this section, we show that such a relaxation of problem (13) can be solved optimally and

Algorithm 4: Post-collision state generation

| | |
|---|---|
| input: | Pre-collision state in world frame |
| | ^{w}xₑ⁻ = [^{w}pₑ^{-T} ^{w}υₓ^{-T} ^{w}aₓ^{-T} . . . ]^{T}; |
| | predicted collision frame [symbol] _{c}; goal |
| | position in world frame ^{w}p_{goal}; obs^{c}. |
| output: | Post-collision state in world frame ^{w}xₑ⁺; |
| | behavior type after collision c. |
| parameter: | Lower bound and upper bound of the |
| | velocity υₘᵢₙ, υₘₐₓ; upper bound of |
| | duration of each primitives τ_{f}, δt. |

| 1 | Function GETPOSTCOLLISIONSTATE (^{w}xₑ⁻, | | |
|---|---|---|---|
| | ^{w}p_{goal}, obs^{c}): | | |
| 2 | \| | ${}^{ω} υ + \frac{{}^{ω} {p}_{goal} - {}^{ω} {p}_{e}^{-}}{{τ}_{f}}$ | |
| 3 | \| | $Generate {ℱ}_{c} and the rotation matrix {}_{c}^{w} R as what$ | |
| | \| | is shown in FIG. 6 given obs^{c} | |
| 4 | \| | ${c}^{} {υ}^{+} {}_{c}^{w} {R}^{T} {w}^{} {υ}^{+}$ | |
| 5 | \| | if ^{c}υₓ⁺ < 0 then | |
| 6 | \| | \| | ^{c}υₓ⁺ 0 |
| 7 | \| | \| | c 2 |
| 8 | \| | \| | We generate a intermediate waypoint ^{w}p_{add} |
| | \| | \| | as what is shown in FIG. 22 given obs^{c} |
| | \| | \| | ${}^{c} υ \text{?} \frac{c}{p {\text{?}}_{d , y}}$ |
| 9 | \| | else | |
| 10 | \| | \| | c 1 |
| 11 | \| | \| | ^{w}p_{add} ← ∅ |

| | | |
|---|---|---|
| 12 | \| | end |
| 13 | \| | ^{w}pₑ⁺ ^{w}p_{c}⁻ |
| 14 | \| | ${c}^{} {υ}^{+} ← {}_{c}^{w} {R}^{T} {w}^{} {υ}^{+}$ |
| 15 | \| | We adjust each components of ^{w}υ⁺ with a |
| | \| | saturation function restricting upper bound and |
| | \| | lower bound as υₘᵢₙ and υₘₐₓ. |
| 16 | \| | We set all derivatives of sₑ⁺ as pₑ^{(q) +} = 0, for all |
| | \| | q ≥ 2. |
| 17 | \| | ^{w}xₑ+ ← [^{w}pₑ^{+ T} ^{w}υₓ^{+ T} ^{w}aₓ^{+ T} . . .]^{T} |

| | |
|---|---|
| 18 | return ^{w}xₑ⁺, c, ^{w}p_{add} |

$\text{?} \text{indicates text missing or illegible when filed}$

efficiently. If p_{add}≠∅, we add a constraint to ensure that the robot will pass the waypoint p_{add} and avoid colliding with the same obstacle multiple times, that is

p(T_{add})=p_{add},∀T_{add}∈[0,T_{g}]. (19)

1) Lower Bound of Time: Intuitively, the constraints on maximum velocity, acceleration, jerk, etc due to X^{obs} and u induce a lower bound T on the minimum achievable time in (13). For example, since the system's maximum velocity is bounded by vₘₐₓ along each axis, if p_{add}=∅, the minimum time for reaching the closest state x_{goal} in the goal region X^{goal} is bounded below by

$${\underline{T}}_{v} = \frac{{‖ {p}_{goal} - {p}_{0} ‖}_{∞}}{{v}_{max}} .$$

The system's maximum acceleration is bounded by aₘₐₓ, hence the state x_{goal}=[p_{goal}^{T} v_{goal}^{T}] cannot be reached faster than

$${min}_{a , {\underline{T}}_{a}} {\underline{T}}_{a} \qquad ( 20 a )$$

$$subject to \dot{x} ( t ) = {A}_{f} x ( t ) + {B}_{f} u ( t ) , u ( t ) = a ( t ) \\ ∀ t ∈ [ 0 , {\underline{T}}_{a} ] \qquad ( 20 b )$$

$$‖ a ( t ) ‖ \leq {a}_{max} \qquad ( 20 c )$$

$$x ( 0 ) = [ \begin{matrix}{p}_{0}^{T} & {{v}_{0}^{T} ]}^{T} , x\end{matrix} ( {\underline{T}}_{a} ) = {[ \begin{matrix}{p}_{goal}^{T} & {v}_{goal}^{T}\end{matrix} ]}^{T} \qquad ( 20 d )$$

The above is a minimum-time optimal control problem with input constraints, which can be solved in closed form along each individual axis to obtain the lower bound Tₐ=min{T_{a,x}, T_{a,y}, T_{a,z}}. This procedure can be continued for constraints higher-order derivatives, but in practice the computed times are less likely to provide better bounds than the previous ones while requiring higher computational effort. Hence, even though we can define a lower bound on the minimum achievable time via T=min{Tᵥ Tₐ, . . . }, for simplicity we use the efficiently computed (but less tight) bound T=Tᵥ. For those cases with p_{add}≠∅, we generate T₁ and T₂ for path segments p₀→p_{add} and

$${p}_{add} \to {p}_{goal} as {\underline{T}}_{1} = {\underline{T}}_{v , 1} = \frac{{‖ {p}_{add} - {p}_{0} ‖}_{∞}}{{v}_{max}} and$$

$${\underline{T}}_{2} = {\underline{T}}_{v , 2} \frac{{‖ {p}_{goal} - {p}_{add} ‖}_{∞}}{{v}_{max}} .$$

2) Velocity Control Linear Quadratic Minimum Time Heuristic Function:

The lower bound T can be used to relax optimization problem (13) by replacing the state and input constraints. If p_{add}=∅, we can deduce

$${min}_{D , {T}_{g}} {J}_{s} ( D ) + {ρ}_{t} {T}_{g} \qquad ( 21 a )$$

$$subject to \dot{x} ( t ) = {A}_{f} x ( t ) + {B}_{f} u ( t ) , ∀ t ∈ [ 0 , {T}_{g} ] \qquad ( 21 b )$$

$$x ( 0 ) = {x}_{0} , x ( {T}_{g} ) ∈ {χ}^{goal} \qquad ( 21 c )$$

$${T}_{g} \geq \underline{T} . \qquad ( 21 d )$$

The relaxed problem (21) is in fact the classical Linear Quadratic Minimum-Time Problem. The optimal cost generated from (21) according to some commentators is:

h(x₀)=δ_{T}^{T}W_{T}⁻¹δ_{T}+ρₜT_{g}. (22)

We define δ_{T}=x_{goal}−e^{A}^{_{f}}^{T}^{_{g}}x₀ and the controllability Gramian W_{T}=∫₀^{T}^{_{g}}^{^{−}}e^{A}^{_{f}}^{t}B_{f}^{T}e^{A}^{_{f}}^{^{T}}^{t}B_{f}dt.

Let us consider velocity control as an illustrative example of (22). Given T_{g}, x₀=p₀, x_{goal}=p_{goal}, we can rewrite the optimal cost of (21) shown in (22) as

$${h}_{v} ( {x}_{0} ) = {C}^{*} ( {T}_{g} ) = \frac{{‖ {p}_{goal} - {p}_{0} ‖}^{2}}{{T}_{g}} + {ρ}_{t} {T}_{g} .$$

Here C* represents the optimal cost which turns out to be a polynomial function of T_{g}. We are able to derive the optimal T_{g}* by minimizing C* in (23) with constraint T_{g}*≥T. The solution of this optimization problem is the positive real root of

$$\frac{{dC}^{*}}{{dT}_{g}} = 0$$

if the positive real root root⁺≥T. Otherwise, T_{g}*=T. Furthermore, the optimal cost is C*(T_{g}*). For the case where p_{add}≠∅, we modify (23) to

$${h}_{v} ( {x}_{0} ) = {C}^{*} ( {T}_{1} , {T}_{2} ) = \frac{{‖ {p}_{add} - {p}_{0} ‖}^{2}}{{T}_{1}} + {ρ}_{t} {T}_{1} + \frac{{‖ {p}_{goal} - {p}_{add} ‖}^{2}}{{T}_{2}} + {ρ}_{t} {T}_{2} \qquad ( 24 )$$

Similarly, we are able to derive the optimal T₁* and T₂* by minimizing C* in (24) with constraints T₁*≥T₁ and T₂*≥T₂.
We can get the solution of this optimization problem by solving the positive real root of

$$\frac{\partial {C}^{*}}{\partial {T}_{1}} = 0 and \frac{\partial {C}^{*}}{\partial {T}_{2}} = 0.$$

The optimal cost then is C*(T₁*, T₂*)

### F. Jump Point-based Computational Efficiency

In the previous subsections from Sec. VI-A to Sec. VI-E, we introduced the overall structure of our proposed collision inclusive search-based motion planning algorithm that is based on A* graph search. From (17), we notice that we extend the feasible set of the optimization problem compared to the collision avoidance planning problem. Extending the feasible set forces our method to traverse more nodes on the graph compared to the collision avoidance method. Even though our method can generate a less conservative result with less cost compared to the collision avoidance method, the computational time of our proposed method is larger than the collision avoidance method.

To improve computational efficiency and reduce the computational time of our method, we can replace the postimpact motion primitive generation technique introduced in Sec. VI-D in A* graph search with a more efficient variant that is inspired by jump point search. Specifically, we notice that when the robot needs to add a new waypoint between the collision point pₑ⁻ of the motion primitive and the goal p_{goal} (c=2), we can modify pₑ⁺=p_{add}. Performing this modification will help us eliminate traversing multiple nodes with the same p_{add}. This way, the number of nodes we are traversing can reduce, thus reducing computational time. Even though applying this technique can result in sacrificing the optimality of the solution, solving the planning problem with less computational time is more important in practice.

If colliding with a convex obstacle (as shown in FIG. 22), we modify pₑ⁺ and duration τ as pₑ⁺←p_{add} and τ←τ+τ_{add} with

$${τ}_{add} = \frac{{}^{c} {p}_{add , y} - {}^{c} {p}_{e , y}^{-}}{{}^{c} {v}_{e , y}^{-}} .$$

The cost will be updated with new τ←τ+τ_{add}. When we go through edges with c=2, we split the trajectory of this given edge with two segments, given the start and the end waypoints as p₀ and pₑ⁻ for the first segment, pₑ⁻ and pₑ⁺ for the second segment. The time duration of the first segment is τ−τ_{add} and the time duration of the second segment is τ_{add}. We set the c=0 and ζ=0 with respect to the waypoint pₑ⁺.

### G. Trajectory Refinement

The resulting trajectory based on the previous sections gives not only the collision-free path, but also the time for reaching the respective waypoints. Thus, we are able to use it as a prior to generate a smoother trajectory in higher dimension for controlling the actual robot. The refined trajectory x*(t) is derived from solving a gradient-based trajectory generation problem similar to the one in Sec. VA with given initial and end states x₀ and x_{goal} and intermediate waypoints pₖ, k∈{0, 1, . . . , N}. The time for each trajectory segment τₖ is also given from the prior trajectory. All pₖ are stored in waypoint list required for Alg. 2. The differential variable of the waypoint with cₖ≥1 is fixed variable instead of free variable in the collision-free method, which indicates

xₖ=xₖ⁻,i∈{0,1, . . . ,N_{c}}cₖ≥1,k∈{0,1, . . . ,N}

We also delete obstacles that the robots planned to collide on (cₖ≥1) when computing the potential field for trajectory generation to simplify calculations. The trajectory after refinement is n-th order continuous. However, the differential of the actual output trajectory changes when a collision occurs, indicating the dynamics of the robot change rapidly during the collision-recovery process. Yet, the overall output trajectory will always be continuous. We can also simplify the waypoint list by deleting waypoints that are collinear with the previous and next waypoints. We reallocate the duration for the simplified segments as the sum of durations of segments before merging. It is important to note that even though the refinement step produces a smoother trajectory, the refined course might be dynamically infeasible; we need to perform time scaling to reduce the maximum dynamics of the refined trajectory. The refined trajectory might collide with the obstacle in the trajectory segment that is checked to be collision free according to Sec. VI-D. In such cases, our DRR strategy ensures robustness and safety.

### VII. Experimental Results

In this section, we validate the effectiveness of our unified framework for collision-inclusive motion planning and control by presenting several benchmark testing results in simulation and via physical experimentation with our robot. 2) First, we test the deformation controller on the robot to test its performance and generate a post-collision model which is required in simulation. 2) Second, we test the local DRR trajectory generation component experimentally with our robot. 3) Then, we test our global planning method in a double corridor environment and compare it with state-of-the-art search-based collision avoidance and sampling-based collision-inclusive methods. 4) After that we test the overall planning strategy in unknown environment. 5) Lastly, we implement the overall method on our impact-resilient robot and test it in a real corridor environment.

### A. Experimental Setup and Implementation Details

Testing the deformation controller (Sec. VII-B) and DRR strategy (Sec. VII-C) experimentally takes place in a 2.0×2.5 m area with a rectangular pillar serving as a static polygon-shaped obstacle. For testing the overall method (Sec. VII-F) experimentally, we consider a 2.5×3.5 m area with a long rectangular pillar right in the middle to create a U-shaped single corridor environment.

We use the two active omni-directional impact-resilient wheeled robots we built in-house. The main chassis is connected to a deflection ‘ring’ via 4 or 8 arms that feature a visco-elastic prismatic joint each. Each arm has embedded Hall effect sensors to measure the length of the arm and detect collisions along each of their direction when the deformation exceeds a certain threshold. In physical experiments, odometry feedback is provided by a 12-camera VICON motion capture system. An onboard Intel NUC mini PC (2:3 GHz i7 CPU; 16 GB RAM) processes odometry data and sends control commands to the robot at 10 Hz. The robot is equipped with a single-beam LIDAR (RPLidar A2) with 8 m range to detect the obstacles in the environment.

The robot may flip when colliding with velocities over a bound. To identify a theoretical collision velocity bound to avoid flipping, we use an energy conservation argument. Assume the kinetic energy before collision transfers into elastic potential energy of the arm, and the gravitational potential energy of the robot with small flipping angle counters the negative work input from the controller, i.e.

E_{k,t}−(vₘₐₓ)=Eₑₚ(lₑ)−Eₑₚ(lₛ)+E_{gp}(σₘₐₓ)+ma_{in,max}(lₛ−l_{c})

Then.

$${v}_{max} = {\{ \frac{k [ {( {l}_{e} - {l}_{0} )}^{2} - {( {l}_{s} - {l}_{0} )}^{2} ]}{2 m} + g ( ρ - {l}_{s} + {l}_{e} ) sin {σ}_{max} + {a}_{in , max} ( {l}_{s} - {l}_{e} ) \}}^{\frac{1}{2}} .$$

The robot's radius is 0.3 m. The difference between the initial and neutral position of each arm is lₛ=30.0 mm, the maximum load length is lₑ=15.0 mm, and the neutral length lₒ=41.5 mm. The spring coefficient is k=2.31 N/mm. We set the largest flip angle σₘₐₓ=3°. For the 4-arm robot, the maximum acceleration input is a_{in,max}=5.0 m/s², and its mass is 6.0 kg. Then, we compute an upper theoretical velocity bound of vₘₐₓ≈0.7 m/s. The 8-arm robot features motors with higher torque and different gear ratio that increase ain;max and despite the mass increase to 8 kg, the same upper theoretical velocity bound remains valid.

Simulated comparison against other methods (Sec. VIID) takes place in a double-corridor environment, whereas simulated benchmark testing of our method when noise is added takes place in the same double-corridor environment but with added isolated obstacles added as well (Sec. VII-E).

We use a rigid cylinder body to emulate the robot. A numerical model is generated from the experiments for the deformation recovery controller to determine the output velocity after collision. The output velocity is generated by adding uniform random noise to the reference velocity ^{c}v_{T}. Then, we use a ray-casting algorithm to emulate the LIDAR (we consider the range of the LIDAR can cover all visible operating space). We implement simulation benchmarks in a python environment. All simulations run on a workstation

with Intel Core Xeon-E2146G CPU.

### B. Experimental Testing of the Deformation Controller

To examine the deformation controller's effect in local trajectory generation, we command the robot to collide with an obstacle and then apply the proposed deformation recovery controller. We perform 10 trials of various input-output velocity combinations. Collision detection is very accurate; only 9 out of 249 were not detected.

Results suggest that the deformation controller generates a negative velocity to make the robot detach from the obstacle after collision. Actual output velocity v̅ₒᵤₜ is determined by the actual input velocity v̅ᵢₙ and the set output value v_{out,set} though the latter may not be reached in practice. That is because feedback linearization is not robust to system parameter uncertainties that occur in practice. We observe that the velocity along the normal to collision direction is closer to the set velocity than the velocity along the tangent direction. This is because most of the uncertainties in system parameters enter as unmodeled friction dynamics along the tangent direction. Further, the sensor is more accurate when the input velocity is along the normal direction; the average value of deformation detected in this case is 29% larger.

### C. Experimental Testing of the DRR Strategy

We test our DRR strategy with a trajectory generated based on using the online safe trajectory generation method with time scaling without collision checking. We compare the strategies in two cases: 1) when the previous path does not intersect with the collision surface; and 2) when the previous path intersects with the collision surface.

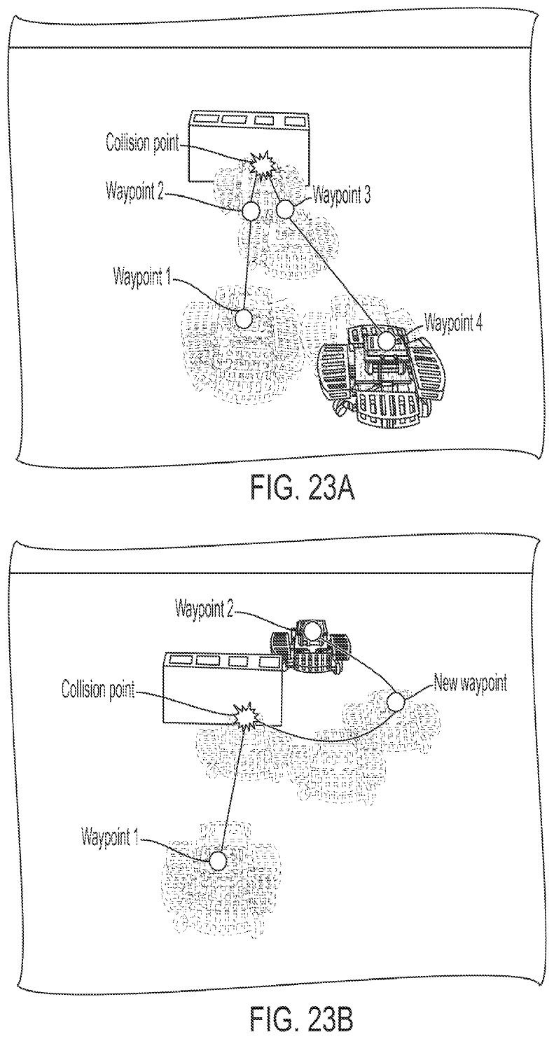

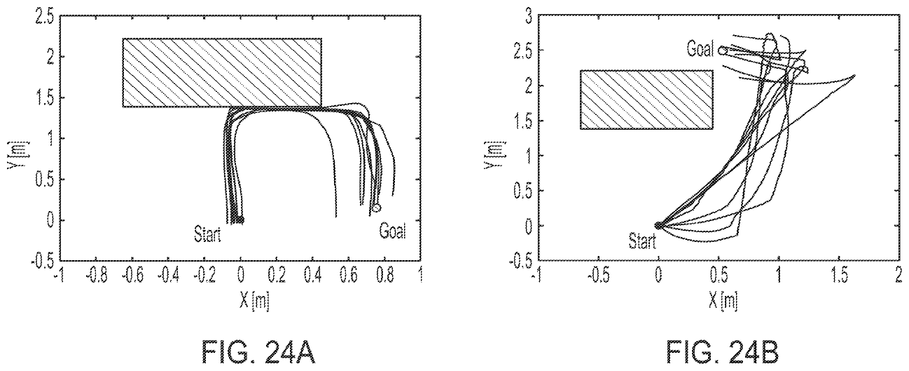

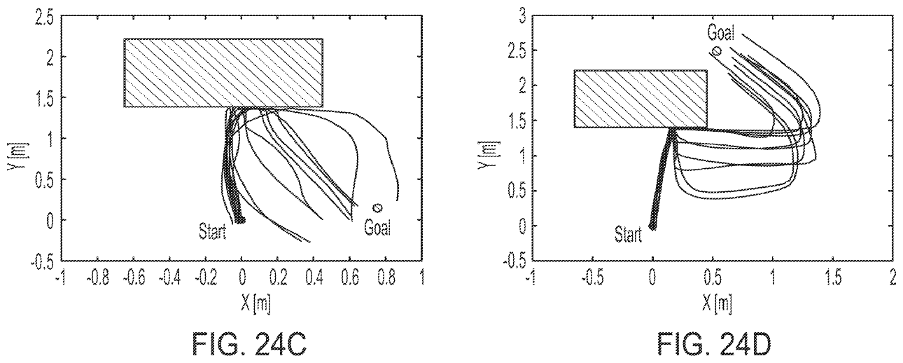

Case 1 tests the condition in FIG. 21A, i.e. no waypoint is added as per Alg. 2. Case 2 tests FIG. 21D, i.e. a waypoint is added to the list. In case 2, we run RRT* to generate a collision free path and perform path simplification to re-move nodes without affecting the path's collision safety. The path simplification technique removes intermediate waypoints between two waypoints if a line segment between those two does not intersect with the obstacle. Then, we use a trajectory generation strategy. We perform 10 trials for each case. Instances of DRR and all experimental trajectories are shown in FIG. 23 and FIG. 24, respectively. FIG. 23A and FIG. 23B show composite images of a sample experiment using a DRR strategy with a robot moving from start to goal passing through all waypoints, including intermediate ones created post-collision, with snapshots shown every 2 seconds. FIG. 24A, FIG. 24B, FIG. 24C, and FIG. 24D show experimental trajectories generated from DRR and collision avoidance trajectory generation strategy when a preplanned path intersects or does not intersect with an obstacle.

Even though we design a collision-free desired trajectory, the robot may still collide with the environment given for instance unmodeled dynamics such as drift. In case 1 there are 3 out of 10 trials that the robot in fact collides with the obstacle applying trajectory generation that aims to avoid collisions. Table II shows statistics on mean arrival times, path lengths and control energy.

TABLE II
Comparison of trajectory generation strategy in (Collision-
avoidance) and DRR (Collision-inclusive) strategies. [49]
C. Richter, A. Bry, and N. Roy, “Polynomial trajectory planning
for aggressive quadrotor flight in dense indoor environments,”
in Robotics Research. Springer, 2016, pp. 649-666.

| | |
|---|---|
| Strategy in [49] | DRR (our method) |

| | Case 1 | Case 2 | Case 1 | Case 2 |
|---|---|---|---|---|
| T̅_{end} [s] | 7.7 | 8.71 | 6.16 | 9.17 |
| STD(T_{end}) | 0 | 2.20 | 0.22 | 0.31 |
| s̅ [m] | 3.153 | 3.448 | 2.977 | 4.38 |
| STD(s) | 0.117 | 0.495 | 0.150 | 0.451 |
| Ē_{c} [m²/s³] | 56.83 | 80.62 | 58.42 | 255.96 |
| STD(E_{c}) | 29.34 | 54.38 | 32.92 | 133.54 |

In case 1 for DRR, mean arrival times T̅_{end} and path length s̅ decrease by 25% and 6%, while the control energy increases by 2.8% on average. However, the error in the end point increases by 25%. In case 2, mean arrival times and path lengths increase by 5.2% and 27%, and control energy increases by 258%. This is because the output velocity of DRR is not flat since the robot needs to decelerate and then accelerate during the boundary following process. Moreover, the path generated by the boundary following is not the shortest. However, since the path between the collision point and the new inserted waypoint is close to the obstacle surface, the existence of the obstacle decreases the control error in free space. The error in the end point decreases by 12%. Overall, these results show the tradeoff between online reactive execution (whereby collision checking is skipped) and collision avoidance.

### D. Simulated Tests of the Collision-inclusive Global Planner

To test our proposed framework in simulation, we first benchmark it in a double corridor environment to test our search-based collision-inclusive global planner. We compare our method for global planning against two methods: 1) a search-based collision-avoidance motion planning algorithm, and 2) an RRT*-based (sampling-based) collision inclusive planning algorithm. Note that no open-source python code is available for either, so we implemented both ourselves to the best possible extent for fair comparisons.

In all tests, the dynamic limits are set as aₘₐₓ=5.0 m/s². The holonomic robot only translates but does not rotate during the process. Constant orientation is maintained via a separate stabilizing controller. We set the upper bound of the robot velocity vₘₐₓ=2.0 m/s. The cost function in all methods considers ρₜ=1.0. The overall size of the map is 70×70 m. The position resolution of the grid map in the benchmark is 1.0 m, and the position resolution of the velocity map in the benchmark is 0.5 m/s. The time interval for each motion primitive is set as τ=5.0 s and the resolution of acceleration r=1.0 m/s². We set λₛ=0.5, λₒ=1.0 and λᵥ=0.1.

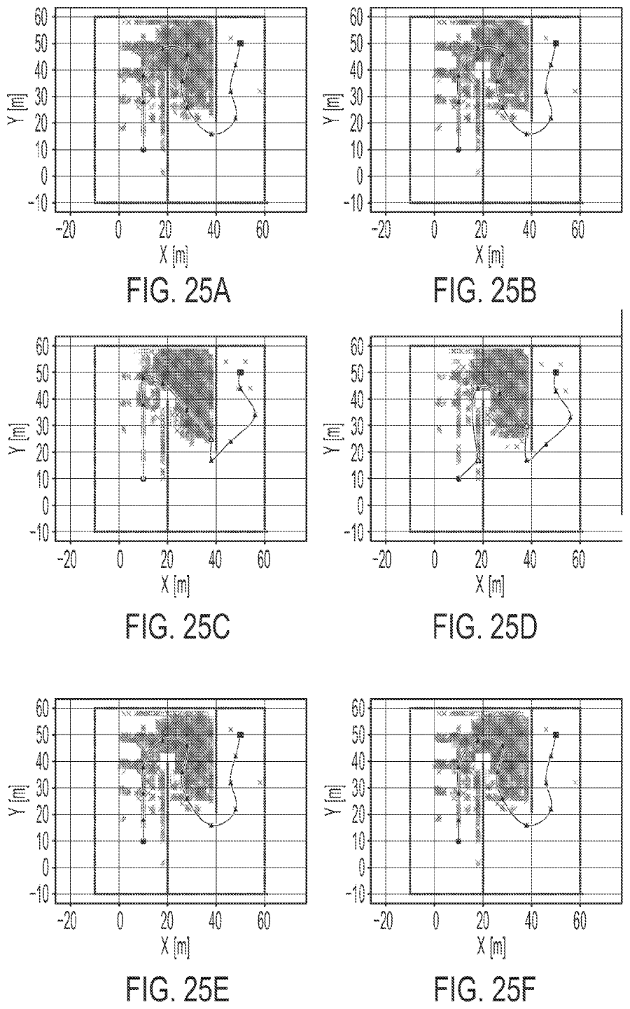

FIGS. 25A, 25B, 25C, 25D, 25E, and 25 F show comparisons between a search-based collision avoidance global planner and a search-based collision inclusive global planner for two different p_{c} values with higher p_{c} values leading to penalizing collisions more with recovering behaviors that resemble collision avoidance.

Results from testing the global planner are shown in FIG. 25; both collision avoidance els A-B) and collision-inclusive (our method, panel C-F) results are highlighted. For the collision avoidance case, we demonstrate the effect of pruning the nodes located in the corner area. We demonstrate our method's results with and without implementing jump points. We also consider two cases where first collisions are not penalized in the cost function (ρ_{c}=1; panels C-D), and second collisions are penalized heavily (ρ_{c}=1000; panels EF) to demonstrate that our method can also produce collision avoidance behaviors, if tuned to dₒ so, and hence highlight its ability to switch between collision-inclusive and collision avoidance planning.

Table III contains more detailed results and also presents comparisons against the sampling-based (RRT*) method. First, both our collision-inclusive method and collision avoidance n generate kinodynamically-feasible trajectories. When the initial velocity is) v₀=[0 0]^{T} m/s and the parameter ρ_{c}=1.0, our method with jump points tends to generate a path with the shortest duration compared to both the collision inclusive planner without jump points and the collision avoidance planner. However, the control cost for doing so is slightly higher. The computational time of the collision inclusive planner with jump points is the second-lowest among all the methods. Comparing these results with those obtained by an RRT* method we find that—in spite that sampling-based methods can solve certain problems that are hard or impossible to solve using graph search—the search-based planning method is more suitable for collision inclusive planning in the configuration space [symbol] ². When there is non-zero initial velocity, v₀[2 2]^{T}>m/s, we find that our proposed collision-inclusive search-based method with jump points tends to generate paths with lowest control energy and time duration. The computational time of our proposed method is also the lowest among all search-based algorithms. Taken together, we deduce that the search-based collision-inclusive method with jump points can serve best as the global planner in our unified collision-inclusive motion planning and control framework.
[22] S. Liu, N. Atanasov, K. Mohta, and V. Kumar, “Search-based motion planning for quadrotors using linear quadratic minimum time control,” in IEEE/RSJ International Conference on Intelligent Robots and Systems (IROS), 2017, pp. 2872-2879.
[38] J. Zha, X. Wu, J. Kroeger, N. Perez, and M. W. Mueller, “A collision-resilient aerial vehicle with icosahedron tensegrity structure,” arXiv preprint arXiv:2003.03417, 2020.

TABLE III
Comparisons of Global Planners' Performance

| | | | | | Ctrl. | |
|---|---|---|---|---|---|---|
| | | Comp. | | Traj. | Cost | Succ. |
| | | Time[s] | Nₚ | Time[s] | [m²/s³] | Rate[%] |
| v₀ = [0 0]^{T} | | | | | | |
| [m/s] | | | | | | |
| method [22] | | 25.1 | 1294 | 60.0 | 36.0 | 100.0 |
| no pruning | | | | | | |
| method [22] | | 21.2 | 1176 | 60.0 | 36.0 | 100.0 |
| with pruning | | | | | | |
| Our method | | 30.8 | 1381 | 60.9 | 32.32 | 100.0 |
| no jump point | | | | | | |
| ρ_{c} = 1.0 | | | | | | |
| Our method | | 23.9 | 1190 | 56.6 | 38.27 | 100.0 |
| with jump point | | | | | | |
| ρ_{c} = 1.0 | | | | | | |
| Our method | | 29.7 | 1261 | 60.0 | 36.0 | 100.0 |
| no jump point | | | | | | |
| ρ_{c} = 1000.0 | | | | | | |
| Our method | | 27.5 | 1261 | 60.0 | 36.0 | 100.0 |
| with jump point | | | | | | |
| ρ_{c} = 1000.0 | | | | | | |
| method [38] | mean | 285.3 | 140 | 565.5 | 17.76 | 90.0 |
| | std | 69.3 | 16.4 | 64.2 | 10.04 | |
| v₀ = [2 2]^{T} | | | | | | |
| method [22] | | 16.5 | 855 | 50.0 | 44.0 | 100.0 |
| no pruning | | | | | | |
| method [22] | | 29.2 | 1304 | 60.0 | 44.0 | 100.0 |
| with pruning | | | | | | |
| Our method | | 41.2 | 1680 | 54.1 | 55.84 | 100.0 |
| no jump point | | | | | | |
| ρ_{c} = 1.0 | | | | | | |
| Our method | | 16.0 | 893 | 55.6 | 35.77 | 100.0 |
| with jump point | | | | | | |
| ρ_{c} = 1.0 | | | | | | |
| Our method | | 32.7 | 1319 | 60.0 | 44.0 | 100.0 |
| no jump point | | | | | | |
| ρ_{c} = 1000.0 | | | | | | |
| Our method | | 30.4 | 1317 | 60.0 | 44.0 | 100.0 |
| with jump point | | | | | | |
| ρ_{c} = 1000.0 | | | | | | |

E. Simulated Tests of our Unified Collision-inclusive Method

We first test our proposed unified collision-inclusive motion planning and control strategy in a double corridor environment with online sensing, and compare its performance against that of a collision avoidance framework. In the collision avoidance framework, the global planner includes a search-based method; we also make the optimistic assumption of treating the unknown space as free. The local planner is the trajectory generation method based on gradients and time duration adjustment. We design a backup safety trajectory to make sure the robot will stop at the frontier. Then, we test both methods in a double corridor environment populated with circular isolated obstacles of increasing density. In both scenarios, each method is run for 10 times with the same initial configuration and parameter settings.

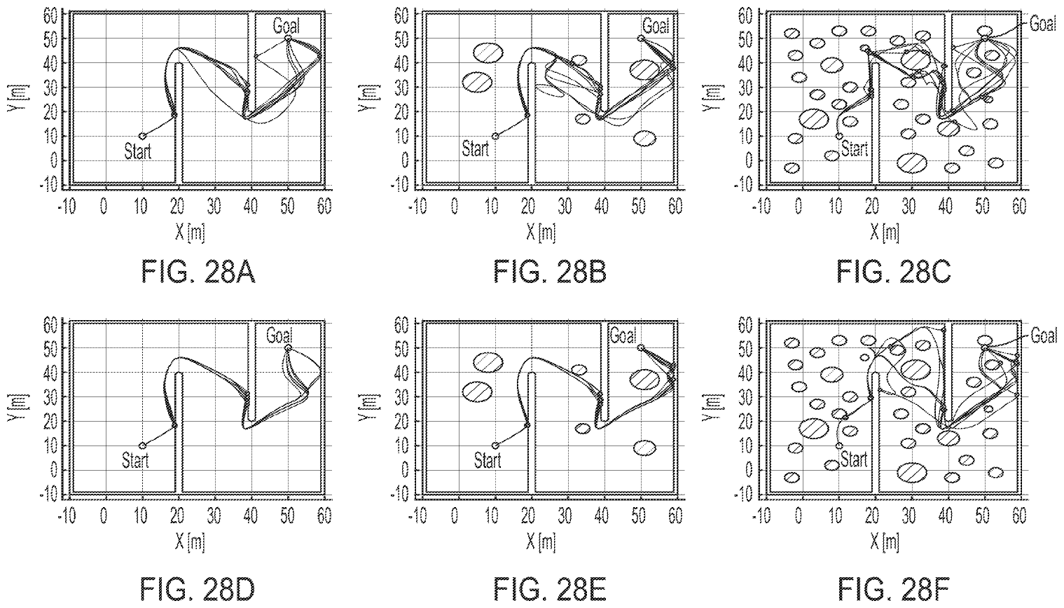

FIGS. 28A, 28B, 28C, 28D, 28E, and 28F show simulated trajectories of a unified collision-inclusive motion planning and control framework with online sensing and noise added to the input of the global planner in a double corridor environment with increasing obstacle density.

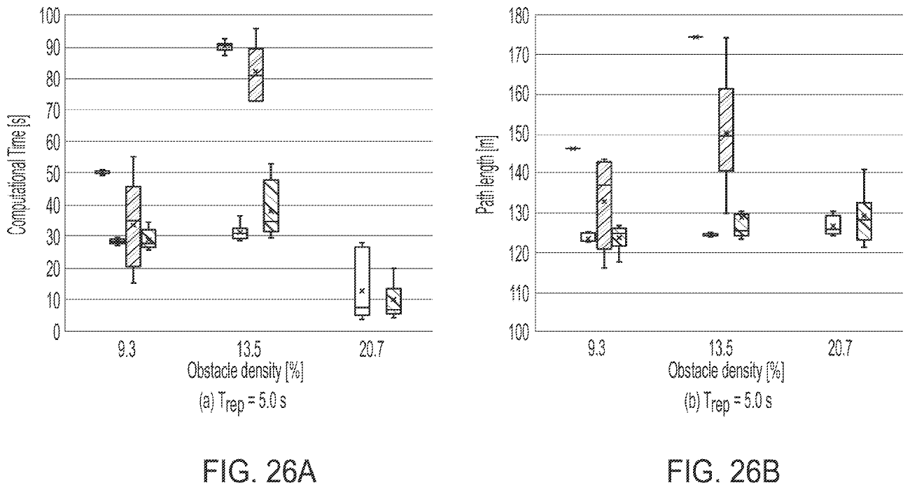

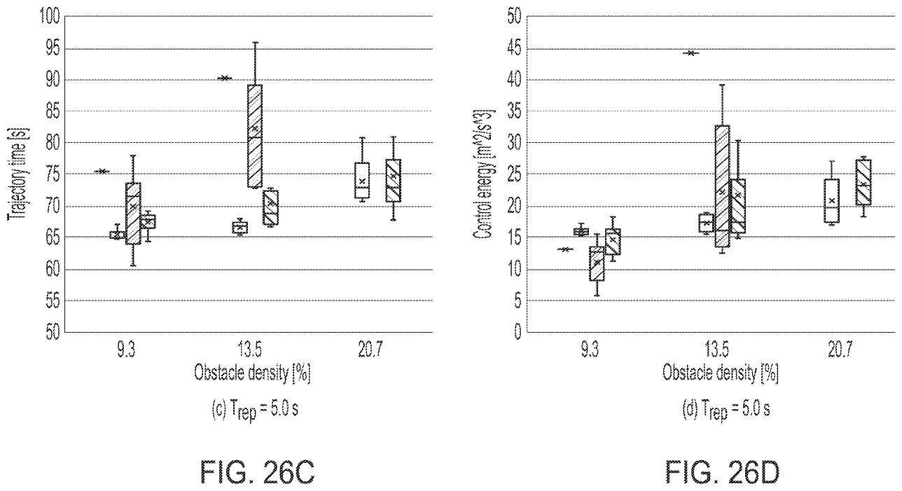

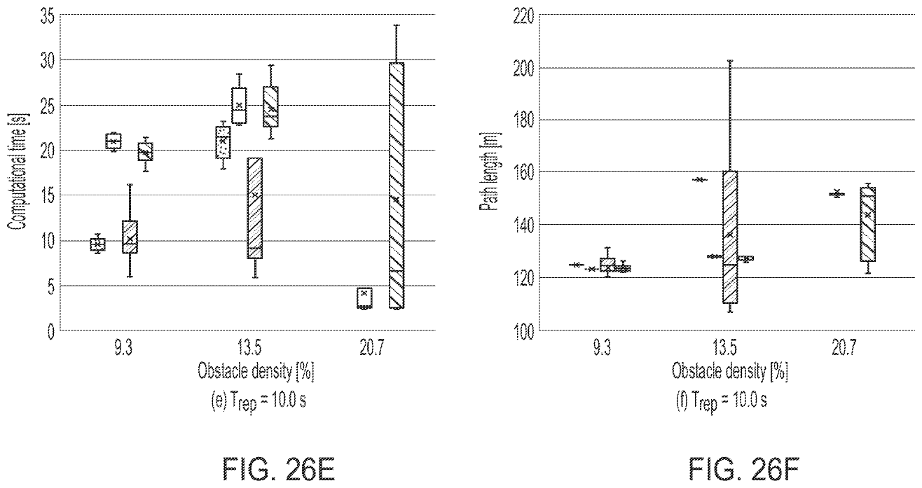

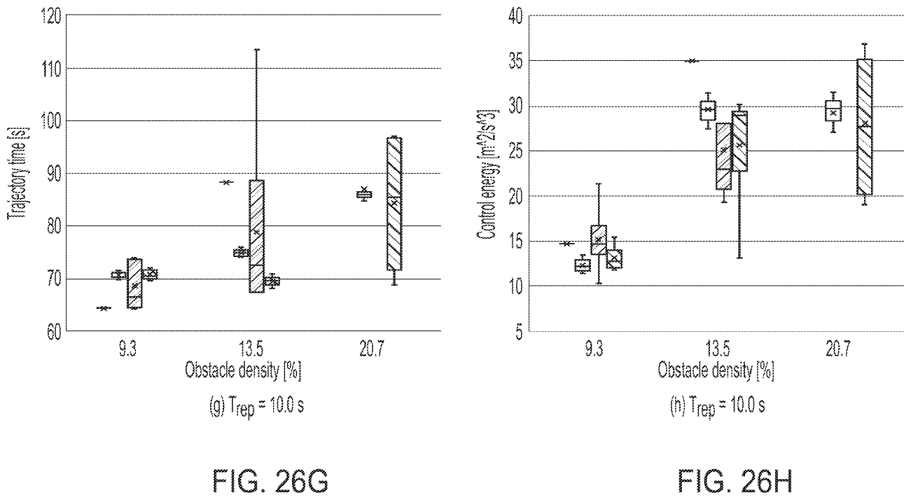

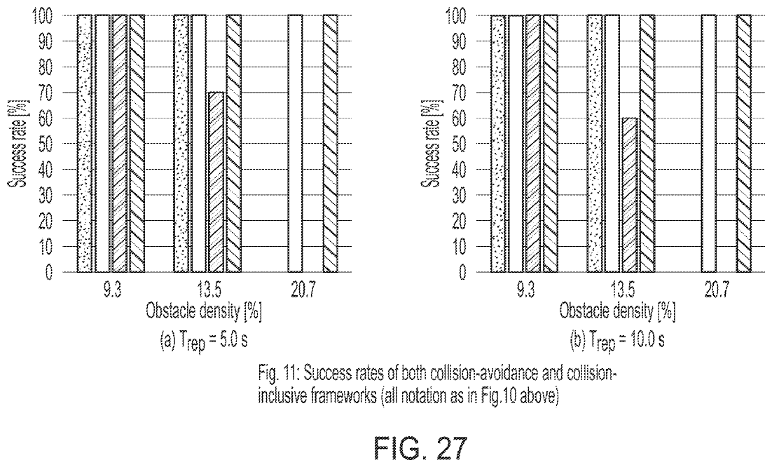

Note that we test with and without estimation noise in the global planner. Added position estimation noise is zero-mean truncated Gaussian with variance of 0.3 and bounds of ±0.9. Added velocity estimation noise is zero-mean truncated Gaussian with variance of 0.1 and bounds of ±0.3. Detailed comparative results are presented in FIGS. 26 and 27. FIGS. 26A, 26B, 26C, 26D, 26E, 26F, 26G, and 26H show computational time, path length, trajectory time and control energy metrics for collision-avoidance (CA) without and with noise and collision-inclusive (CI) without and with noise frameworks, for two cases of replanning time Trep=5:0 s and Trep=10:0 s. FIG. 27 shows success rates of both collision-avoidance and collision-inclusive frameworks. All output trajectories of our proposed method (with added noise) are shown in FIG. 27.

With reference to FIG. 26, when replanning at every 5 sec, our proposed collision-inclusive method generates shorter path with a lower trajectory time on average. When the obstacle density is low (9.3%), our method generates trajectories with higher control energy; however, when the obstacle density increases (13.5% & 20.7%) our method requires lower control energy since the robot can utilize the obstacles to change its heading more conveniently. When replanning at every 10 sec, our method consistently generates paths with lower length on average. Yet, when the obstacle density is low, our method has higher trajectory times since the frequency of updating the map is lower and the robot is allowed to generate trajectories with longer time than the actual optimal trajectory. However, the collision-inclusive motion planning strategy returns a feasible solution even if it is far from optimal value.

Further, success rates of the proposed collision-inclusive method and collision avoidance are shown in FIG. 27. Our method has higher success rates since it addresses over-conservativeness caused in collision avoidance to ensure safety. The parameters of global and local planners are the same as Sec. VII-D.

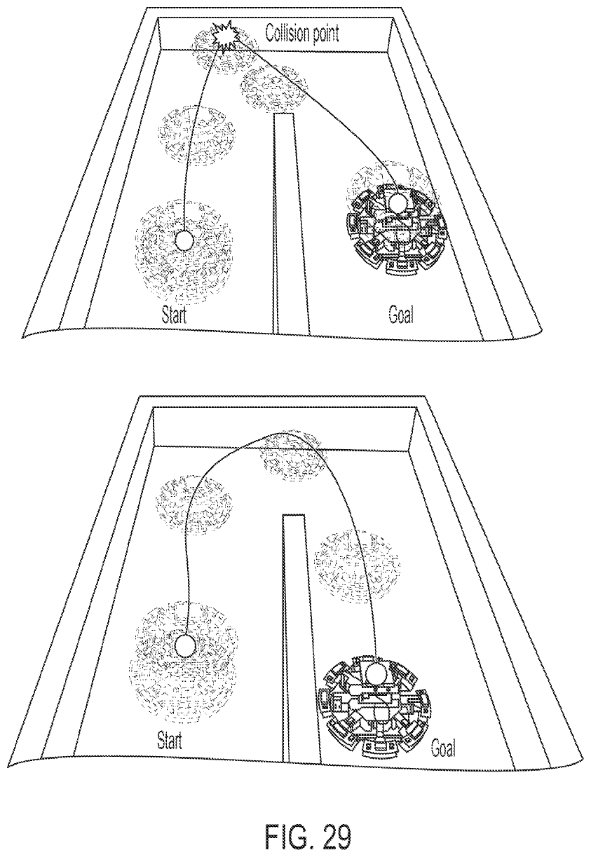

FIG. 29 shows composite images of a sample experiment with a unified collision-inclusive motion planning and control framework and of a collision avoidance sample experiment with snapshots shown every 2:5 seconds Snapshots shown every 2.5 s.

### F. Experimental Validation of our Framework

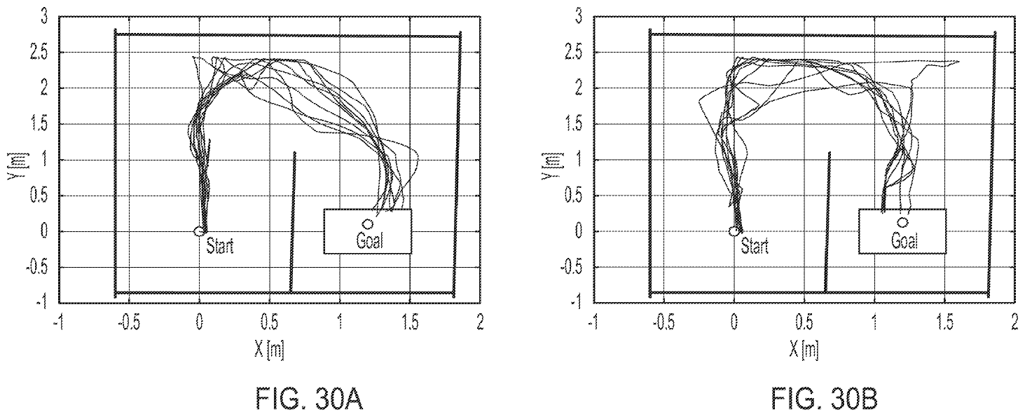

Finally, we validate our proposed framework experimentally, and also test is against the collision avoidance strategy in Sec. VII-E, in a single corridor environment (FIG. 29). Each method is repeated for 10 times using the same parameter settings. Output trajectories are depicted in FIG. 30, while detailed numerical results are given in Tab. IV. FIGS. 30A and 30B show experimental trajectories generated from a collision-inclusive method and the collision avoidance method.

By implementing our proposed collision-inclusive planning method, the robot can reach the goal area with higher success rates since unmodeled dynamics in real robot planning and control make the robot collide with the obstacle even if the reference trajectory generated from collision avoidance method is designed to be collision-free. Further, by utilizing collisions, the robot can reach the goal faster while requiring less control energy by trading off the average path length.

TABLE IV
Comparison of collision-inclusive and collision
avoidance framework in real robot

| | | Path | Traj. | Ctrl. | Succ. |
|---|---|---|---|---|---|
| | | Len.[m] | Time[s] | Cost[m²/s³] | Rate[%] |
| Collision-avoidance | mean | 4.99 | 12.74 | 38.32 | 90.0 |
| | std | 1.80 | 2.61 | 16.75 | |
| Collision-inclusive | mean | 5.36 | 11.98 | 32.45 | 100.0 |
| | std | 0.33 | 1.19 | 10.05 | |

The application describes a unified collision-inclusive motion planning and control framework applied for navigation in unknown environment. A global search-based method is devised to generate a path which contains explicit information about collisions. The effect of the collisions is explored in the global planner. The local planner is enhanced by a lower-level deformation recovery control and trajectory replanning strategy, which enables the robot to detect and recover from collisions and move toward the goal. The deformation controller is designed based on the dynamics of the robot, which herein is a holonomic omni-directional wheeled robot. This part can be easily swapped out with another robot model if the robot dynamics change, while other parts of the overall method stay the same. The planning system was evaluated extensively through several benchmark comparisons in simulation as well as via physical experimental testing. The proposed collision-inclusive planning method is implemented in simulation first and then integrated with state estimation, mapping and control into our custom-made robot platform to check the feasibility of the method in physical world experiments. Results show that the proposed method is robust and capable to generate fast and safe trajectories compared to collision-avoidance methods.

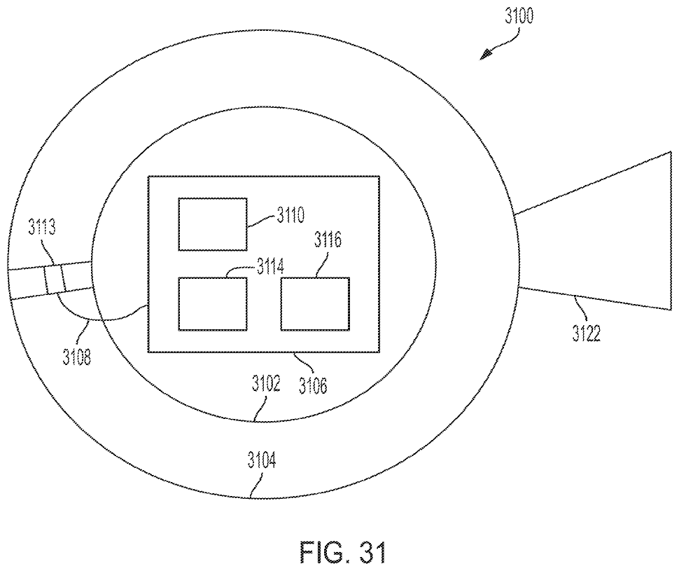

FIG. 31 shows an illustration of a collision-resistant robot 3100 in accordance with some embodiments of the present disclosure. The collision resistant robot 3100 is not limited to a particular type of robot. In some embodiments, the robot 3100 is an aerial vehicle robot. In some embodiments, the robot 3100 is a terrestrial vehicle robot. The collision resilient robot 3100 includes main chassis 3102, a deflection surface 3104, and a processor 3106. The processor 3106 is configured to receive a collision signal 3108 after deformation of the collision-resilient robot 3100 from a collision (collision signal receiver module 3110). The collision signal 3108 is provided by a sensor 3113. In some embodiments, the sensor 3113 is the sensing system 114 (shown in FIG. 1). The processor 3106 is configured to recover control of the collision-resilient robot after a collision (collision recovery module 3114). And the processor is configured to plan a post-collision trajectory for the collision-resilient robot using a global search-based planner (global search-based planner 3116). In some embodiments, the collision resilient robot 3100 includes an arm 102 (shown in FIG. 1) located between the deflection surface 3104 and the main chassis 3102 with the sensor 3113 embedded in the arm 102. In some embodiments, the sensor 3113 is a Hall effect sensor. In operation, the global search-based planner 3116 uses information from the sensor 3113 to plan a post-collision trajectory for the collision-resilient robot 3100. In operation, the collision-resilient robot 3100 has a field of view 3122 and the global search-based planner 3116 evaluates possible collisions within the field of view 3122 and outside the field of view 3122 to plan the post collision trajectory. In operation, the global search-based planner 3116 adjusts one or more waypoints of a preplanned trajectory with information obtained from the collision to generate the post-collision trajectory plan. In operation, the global search-based planner 3116 evaluates effects of possible collisions and determines when a preferred post-collision trajectory is to collide with a surface instead of avoiding the surface.

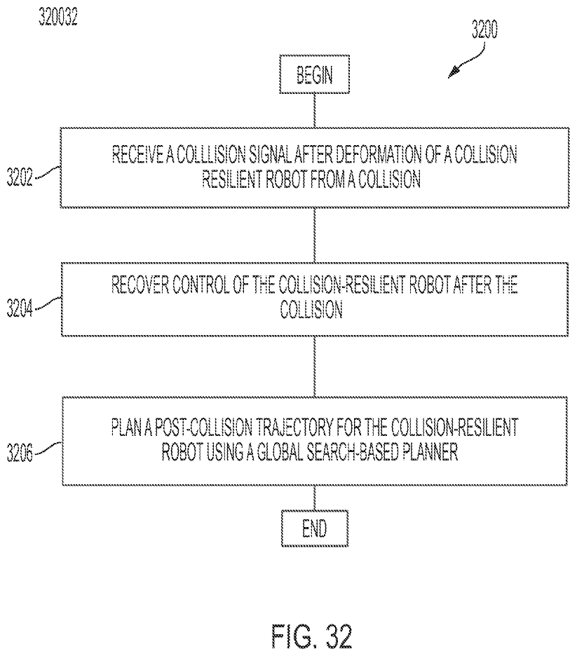

FIG. 32 shows a flow diagram of a method 3200 in accordance with some embodiments of the present disclosure. The method 3200 includes receiving a collision signal after deformation of a collision-resilient robot from a collision (block 3202), recovering control of the collision-resilient robot after the collision (block 3204), and planning a post-collision trajectory for the collision-resilient robot using a global search-based planner (block 3206). In some embodiments, recovering control of the collision-resilient robot after the collision includes, for the collision-resilient robot having an orientation after the collision, maintaining the orientation throughout the collision recovery process. In some embodiments, planning the post-collision trajectory for the collision-resilient robot after the collision using the global search-based planner includes using a post-collision state determined while recovering control of the collision-resilient robot after the collision as the initial state for post-collision trajectory generation. In some embodiments, planning the post-collision trajectory for the collision-resilient robot after the collision using the global search-based planner includes, for the collision-resilient robot having a collision state, planning the post-collision trajectory when there is no direct line of sight between the collision state and a waypoint at an end of an immediately next trajectory segment following collision recovery.

In the preceding specification, various example embodiments have been described with reference to the accompanying drawings. It will, however, be evident that various modifications and changes can be made thereto, and additional embodiments may be implemented based on the principles of the present disclosure. The specification and drawings are accordingly to be regarded in an illustrative rather than restrictive sense.

For example, advantageous results still could be achieved if steps of the disclosed techniques were performed in a different order or if components in the disclosed systems were combined in a different manner or replaced or supplemented by other components. Other implementations are also within the scope of the following example claims.

What is claimed is:

1.-14. (canceled)

15. A method comprising:
generating a collision signal for an aerial vehicle in response to a collision; and
processing the collision signal to identify an axis of the aerial vehicle from which the collision signal originated.

16. The method of claim 15, wherein generating the collision signal for the aerial vehicle in response to the collision comprises detecting compression of an arm of the aerial vehicle.

17. The method of claim 15, wherein generating the collision signal for the aerial vehicle in response to the collision comprises processing a Hall effect sensor signal generated from a change in a length of a flexible member included in the aerial vehicle.

18. The method of claim 15, wherein generating the collision signal for the aerial vehicle in response to the collision comprises detecting the collision without inertial measurement unit data.

19. The method of claim 15, further comprising estimating deformation of the aerial vehicle resulting from the collision.

20. The method of claim 15, further comprising processing the collision signal to identify an intensity of the collision.

21.-25. (canceled)

26. A method comprising:
receiving a collision signal after deformation of a collision-resilient robot from a collision;
recovering control of the collision-resilient robot after the collision; and
planning a post-collision trajectory for the collision-resilient robot using a global search-based planner.

27. The method of claim 26, wherein recovering control of the collision-resilient robot after the collision comprises, for the collision-resilient robot having an orientation after the collision, maintaining the orientation throughout the collision recovery process.

28. The method of claim 26, wherein planning the post-collision trajectory for the collision-resilient robot after the collision using the global search-based planner comprises using a post-collision state determined while recovering control of the collision-resilient robot after the collision as the initial state for post-collision trajectory generation.

29. The method of claim 26, wherein planning the post-collision trajectory for the collision-resilient robot after the collision using the global search-based planner comprises, for the collision-resilient robot having a collision state, planning the post-collision trajectory when there is no direct line of sight between the collision state and a waypoint at an end of an immediately next trajectory segment following collision recovery.

30. A collision resilient robot comprising:
a processor configured to:
receive a collision signal after deformation of the collision-resilient robot from a collision;
recover control of the collision-resilient robot after the collision; and
plan a post-collision trajectory for the collision-resilient robot using a global search-based planner.

31. The collision resilient robot of claim 30, wherein the collision signal is generated from a sensor embedded between a main chassis and a deflection surface of the collision resilient robot.

32. The collision resilient robot of claim 31, wherein the global search-based planner uses information from the sensor to plan a post-collision trajectory for the collision-resilient robot.

33. The collision resilient robot of claim 30, wherein the collision-resilient robot has a field of view and the global search-based planner evaluates possible collisions within the field of view and outside the field of view to plan the post collision trajectory.

34. The collision resilient robot of claim 30, wherein the global search-based planner adjusts one or more waypoints of a preplanned trajectory with information obtained from the collision to generate the post-collision trajectory plan.

35. The collision resilient robot of claim 30, wherein the global search-based planner evaluates effects of possible collisions and determines when a preferred post-collision trajectory is to collide with a surface instead of avoiding the surface.

36. The collision resilient robot of claim 30, further comprising an arm to couple a main chassis of the collision resilient robot to a deflection surface.
